(19) United States
(12) Patent Application Publication
(10) Pub. No.: US 2018/0268458 A1
(43) Pub. Date: Sep. 20, 2018

(54) AUTOMATED RECOMMENDATION AND VIRTUALIZATION SYSTEMS AND METHODS FOR E-COMMERCE

(71) Applicant: VALORBEC LIMITED PARTNERSHIP, Montreal (CA)

(72) Inventors: Tiberiu POPA, Montreal (CA); Amir Zafar ASOODEH, Montreal (CA)

(21) Appl. No.: 15/541,525

(22) PCT Filed: Jan. 5, 2016
(86) PCT No.: PCT/CA2016/000002

§ 371 Date: Jul. 5, 2017

Related U.S. Application Data
(60) Provisional application No. 62/099,755, filed on Jan. 5, 2015.

(51) Int. Cl. G06Q 30/06; G06K 9/00; G06K 9/40; G06K 9/46; G06Q 30/02

(52) U.S. Cl. CPC G06Q 30/0631; G06K 9/00275; G06Q 30/02; G06K 9/40; G06K 9/4604; G06K 9/00288

(57) ABSTRACT

Visual appearance is a significant aspect of how we perceive others and how we want to be perceived. With items such as eyewear, make-up and facial jewelry the style, colour, size not only impact how others perceive us based upon the selections themselves but also how these fit or suit the user's face, which is unique. With online retailing the purchaser does not get feedback as in bricks-and-mortar retailing from friends, retail assistants etc. At best the user is exposed to a basic recommendation system which is generally procedural based with a priori aesthetic rules and user classification. However, users are often incorrect in their classification of themselves whilst the aesthetic rules are hidden, can contradict, and do not take into account current fashion, age or culture. Embodiments of the invention provide automated recommendation engines for retail applications based upon simply acquiring an image of the user.

### CROSS-REFERENCE TO RELATED APPLICATIONS

This patent application claims the benefit of priority from Patent Cooperation Treaty application PCT/CA2016/000002 filed Jan. 5, 2016 entitled “Automated Recommendation and Virtualization Systems and Methods for E-Commerce” which itself claims priority from U.S. Provisional Patent Application U.S. 62/099,755 filed Jan. 5, 2015 entitled “Automated Recommendation and Virtualization Systems and Methods for E-Commerce.”

### FIELD OF THE INVENTION

This invention relates to recommendation systems and more particularly to automated image processing based recommendation systems.

### BACKGROUND OF THE INVENTION

Visual appearance is a significant aspect of our lives both in terms of how we are perceived, how we want to be perceived, and impacts many aspects of our social and work lives. Globally expenditure on corrective eyewear, protective eyewear is estimated at approximately $90 billion and is expected to grow to approximately $140 billion in 2020. An incorrect purchasing decision can be not only expensive but lead to a reduction in the user's visual aesthetic overall. Additionally, global consumption of make-up is expected to reach $40 billion in 2015 whilst facial jewelry such as earrings accounts for a proportion of the current $275 billion global jewelry market.

Against this backdrop the average consumer is now able to acquire their purchases from a bewildering array of online retailers in addition to the conventional bricks-and-mortar retailer. The items they purchase range from must-haves, e.g. corrective lenses, to fashion items with iconic brands and overwhelming supply of hundreds and thousands of designs across a wide range of retail price points. However, online the user today is exposed to, at best a basic, and typically no recommendation system to guide or support their purchasing activity. Most prior art recommendation systems are generally procedural based on some a priori aesthetic rules and not necessarily based on real data. These rules are opaque to the user, occasionally contradicting each other and are based on rigid aesthetic principles that do not take into account current fashion, age or culture.

Accordingly, it would be beneficial to provide the consumer with a more flexible, data driven recommendation framework that can aggregate large databases of faces and items of different categories such as glasses, jewelry, clothing etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating recommendation systems and more particularly to automated image processing based recommendation systems.

In accordance with an embodiment of the invention there is provided method comprising: automatically establishing with a microprocessor based system a facial shape for a user based
upon an image of the user provided to the microprocessor based system comprising a classification engine, wherein
the classification engine automatically processes the image of the user with a predetermined classifier exploiting a training set.

In accordance with an embodiment of the invention there is provided a method comprising:

automatically establishing a facial shape for a user based upon an image of the user provided to a software system comprising a plurality of modules, wherein
a first module of the plurality of modules provides for facial boundary detection based upon a provided image, the facial boundary detection establishing a predetermined number of boundary points;
a second module of the plurality of modules provides for feature extraction based upon the boundary points established by the first module, the feature extraction comprising the generation of predetermined geometric shapes based upon first subsets of the boundary points and dimensions established upon second subsets of the boundary points; and
a classification module of the plurality of modules for determining a facial shape in dependence upon the features extracted by the second module and a plurality of datasets, each of the datasets established from feature extraction performed upon a training set of images relating to a defined facial shape of a plurality of defined facial types.

In accordance with an embodiment of the invention there is provided a method comprising:
automatically establishing an eyewear frame class of a plurality of eyewear frame classes for a user with a microprocessor based system comprising a classification engine based upon an image of the user provided to the microprocessor based system, wherein
the classification engine automatically processes the image based upon a first case based reasoning methodology exploiting a first training set to define a facial shape of the user and associates the defined facial shape with an eyewear frame class of a plurality of eyewear frame classes; and
the associations between facial shapes and eyewear frame classes were previously established by the classification engine based upon a second case based reasoning methodology exploiting a second training set of images comprising images of other users wearing eyewear frames.

In accordance with an embodiment of the invention there is provided a method comprising:
automatically establishing a digital fingerprint of an eyewear frame worn by a user based upon an image comprising at least the eyewear frame; and
automatically establishing a frame class for the eyewear frame with a microprocessor based system comprising a classification engine, wherein
the classification engine automatically processes the image of the user with a predetermined classifier exploiting a training set.

In accordance with an embodiment of the invention there is provided a method of providing a recommendation to a user with respect to an item comprising:
automatically establishing with a microprocessor based system a facial shape for a user based upon an image of the user provided to the microprocessor based system comprising a classification engine which automatically processes the image of the user with a predetermined classifier exploiting a training set; and
automatically establishing a class of the item in dependence upon the facial shape of the user and the results of a survey executed in respect of a plurality of classes of the item and a plurality of facial types; and
automatically generating a recommendation in dependence upon the established class of the item.

In accordance with an embodiment of the invention there is provided a method of surveying to establish a recommendation comprising:
providing to each surveyed user of a plurality of surveyed users a plurality of images, each image within the plurality of images comprising an image of an individual of a plurality of individuals within a user class of a plurality of user classes and an item within an item class of a plurality of item classes;
receiving the responses from the plurality of surveyed users with respect to the plurality of images; and
ranking the item classes for each of the plurality of user classes in dependence upon the received responses.

In accordance with an embodiment of the invention there is provided a method of providing a recommendation to a user with respect to an item comprising:
acquiring a plurality of purchased item data records each comprising an identity of an individual and an identity of an item;
classifying each individual to a user class of a plurality of user classes;
classifying each item to an item class of a plurality of item classes;
establishing a ranking for each user class of the plurality of user classes for the plurality of item classes; and
upon receiving data relating to a user automatically classifying the user to a user class of the plurality of user classes and providing a recommendation comprising the highest ranked item class of the plurality of item classes for the classified user class of the plurality of user classes of the user.

In accordance with an embodiment of the invention there is provided a non-transitory non-volatile computer readable medium storing executable instructions thereon that, when executed by a microprocessor, perform a method comprising the steps:
automatically establishing with a microprocessor based system a facial shape for a user based upon an image of the user provided to the microprocessor based system comprising a classification engine, wherein
the classification engine automatically processes the image of the user with a predetermined classifier exploiting a training set.

In accordance with an embodiment of the invention there is provided a non-transitory non-volatile computer readable medium storing executable instructions thereon that, when executed by a microprocessor, perform a method comprising the steps:
automatically establishing an eyewear frame class of a plurality of eyewear frame classes for a user with a microprocessor based system comprising a classification engine based upon an image of the user provided to the microprocessor based system, wherein
the classification engine automatically processes the image based upon a first case based reasoning methodology exploiting a first training set to define a facial shape of the user and associates the defined facial shape with an eyewear frame class of a plurality of eyewear frame classes; and
the associations between facial shapes and eyewear frame classes were previously established by the classification engine based upon a second case based reasoning methodology exploiting a second training set of images comprising images of other users wearing eyewear frames.

In accordance with an embodiment of the invention there is provided a non-transitory non-volatile computer readable medium storing executable instructions thereon that, when executed by a microprocessor, perform a method comprising the steps:
automatically establishing a digital fingerprint of an eyewear frame worn by a user based upon an image comprising at least the eyewear frame; and
automatically establishing a frame class for the eyewear frame with a microprocessor based system comprising a classification engine, wherein
the classification engine automatically processes the image of the user with a predetermined classifier exploiting a training set.

In accordance with an embodiment of the invention there is provided a non-transitory non-volatile computer readable medium storing executable instructions thereon that, when executed by a microprocessor, perform a method comprising the steps:
automatically establishing with a microprocessor based system a facial shape for a user based upon an image of the user provided to the microprocessor based system comprising a classification engine which automatically processes the image of the user with a predetermined classifier exploiting a training set; and
automatically establishing a class of the item in dependence upon the facial shape of the user and the results of a survey executed in respect of a plurality of classes of the item and a plurality of facial types; and
automatically generating a recommendation in dependence upon the established class of the item.

In accordance with an embodiment of the invention there is provided a non-transitory non-volatile computer readable medium storing executable instructions thereon that, when executed by a microprocessor, perform a method comprising the steps:
providing to each surveyed user of a plurality of surveyed users a plurality of images, each image within the plurality of images comprising an image of an individual of a plurality of individuals within a user class of a plurality of user classes and an item within an item class of a plurality of item classes;
receiving the responses from the plurality of surveyed users with respect to the plurality of images; and
ranking the item classes for each of the plurality of user classes in dependence upon the received responses.

In accordance with an embodiment of the invention there is provided a non-transitory non-volatile computer readable medium storing executable instructions thereon that, when executed by a microprocessor, perform a method comprising the steps:
acquiring a plurality of purchased item data records each comprising an identity of an individual and an identity of an item;
classifying each individual to a user class of a plurality of user classes;
classifying each item to an item class of a plurality of item classes;
establishing a ranking for each user class of the plurality of user classes for the plurality of item classes; and
upon receiving
data relating to a user automatically classifying the user to a user class of the plurality of user classes and providing a recommendation comprising the highest ranked item class of the plurality of item classes for the classified user class of the plurality of user classes of the user.

In accordance with an embodiment of the invention there is provided a system comprising:

a software system comprising:
a first module provides for facial boundary detection based upon a provided image, the facial boundary detection establishing a predetermined number of boundary points;
a second module provides for feature extraction based upon the boundary points established by the first module, the feature extraction comprising the generation of predetermined geometric shapes based upon first subsets of the boundary points and dimensions established upon second subsets of the boundary points;
a classification module for determining a facial shape in dependence upon the features extracted by the second module and a plurality of datasets, each of the datasets established from feature extraction performed upon a training set of images relating to a defined facial shape of a plurality of defined facial types; wherein
   the software system automatically establishes a facial shape for a user based upon an image of the user provided to the first module.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an example of virtual eyewear frame visualization for a user according to the prior art;

FIG. 2 depicts schematically an eyewear recommendation system according to an embodiment of the invention;

FIG. 3 depicts a Face Shape Recognition System (FSRS) process flow for a recommendation system according to an embodiment of the invention;

FIG. 4 depicts a sample output for a detected face boundary step within an FSRS process flow for a recommendation system according to an embodiment of the invention;

FIG. 5 depicts the facial contour points for a detected face boundary step within an FSRS process flow for a recommendation system according to an embodiment of the invention;

FIG. 6 depicts the variation of geometric facial features for different face types established using a detected face boundary step within an FSRS process flow for a recommendation system according to an embodiment of the invention;

FIGS. 7 to 12 depict schematically different facial features extracted after a detected face boundary step within an FSRS process flow for a recommendation system according to an embodiment of the invention;

FIG. 13 depicts six different facial types employed within a Face Shape Recognition System (FSRS) for a recommendation system according to an embodiment of the invention;

FIG. 14 depicts an exemplary scenario of CBR for a FSRS according to an embodiment of the invention;

FIG. 15 depicts steps within an eyewear frame shape extraction process for an eyewear recommendation system according to an embodiment of the invention;

FIG. 16 depicts difficult examples for an eyewear frame shape extraction process for an eyewear recommendation system according to an embodiment of the invention;

FIG. 17 depicts examples of standard eyewear frame shapes;

FIG. 18 depicts geometric features employed for frame shape classification according to an embodiment of the invention;

FIG. 19 depicts extracted convex hull and fitted oval for six standard frame shapes using frame shape classification system according to an embodiment of the invention;

FIG. 20 depicts examples of mixed class shapes for face and eyewear frames extracted using facial and frame shape classification systems according to embodiments of the invention;

FIG. 21 depicts a typical page presented to a voter within a survey website employed by the inventors;

FIGS. 22 and 23 depict accuracy diagrams obtained during the testing phase of the FSRS according to an embodiment of the invention;

FIG. 24 depicts the population survey results for the 36 face/frame classes;

FIG. 25 depicts the number of votes for each image in each of the 36 face/frame classes;

FIG. 26 depicts the survey results of the approximately 100 participants;

FIG. 27 depicts an entry within the validation query for a user with four frames presented;

FIG. 28 depicts a network environment within which embodiments of the invention may be employed;

FIG. 29 depicts a wireless portable electronic device supporting communications to a network such as depicted in FIG. 2 and as supporting embodiments of the invention.

### DETAILED DESCRIPTION

The present invention is directed to recommendation systems and more particularly to automated image processing based recommendation systems.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, and teenagers. In its broadest sense the user may further include, but not be limited to, mechanical systems, robotic systems, android systems, etc. that may be characterised by a portion of the body being identifiable to a human as a face.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

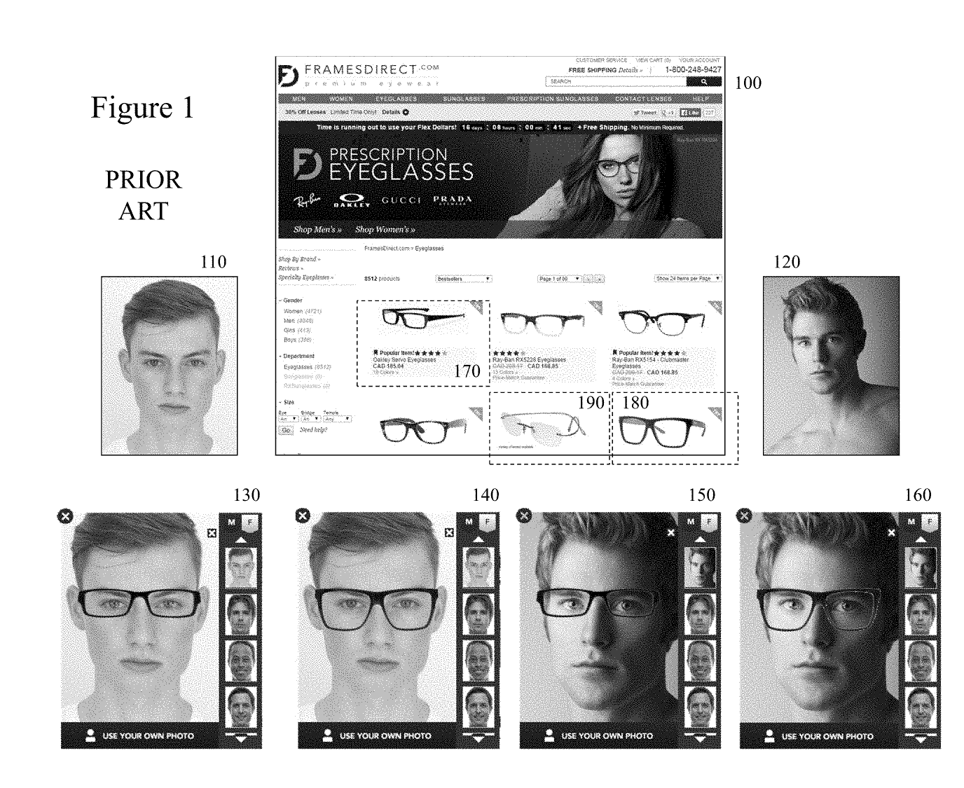

FIG. 1A depicts an example of virtual eyewear frame visualization for a user according to the prior art as employed by Frames Direct (www.framesdirect.com). As depicted a user viewing frames for sale on their website 100 is presented with 4721 eyewear frame options for women (referred to as frames for ease throughout the specification), 4048 frames, 413 frames for girls, and 396 for boys. The user can search through the website 100 using a variety of filters including, for example, lens type (single vision, bifocal, progressive), style (classic, cool, trendy, hipster, nerdy, retro. sporty, designer, and unique), frame material, colour, frame type, frame shape, brand, and price. Some of the styles, e.g. first and second frames 170 and 180, have next to them a “TRY” marker whilst others such as third frame 190 have nothing. Accordingly, the user must make a judgment of such frames blindly. However, even with first and second frames 170 and 180 the situation is not much better. If the user selects, the “TRY” marker then a pop-up window appears with a series of default faces, which can be set as male or female, upon which the frame is overlaid and the user has a small image displayed, approximately 50 mm×40 mm (approximately 2″×1.5″). However, the user can upload their own image, e.g. first and second user images 110 and 120 respectively and view the overlaid frame(s). Accordingly, first to fourth images 130 to 160 respectively represent the results presented using first and second user imaged 110 and 120 respectively with first and second frames 170 and 180 respectively. As evident the frame image is fixed within the pop-up windows comprising first to fourth images 130 to 160 respectively and the system has attempted to resize and re-orientate the user's head to fit a template but as the translation and image rotation are only in the image plane this works only for front facing images.

Accordingly, as first user image 110 was chosen to be face on and comparable to the default faces within the website 100 placement of the frames is only slightly off laterally but is off vertically. The second user image 120 by being tilted results in tilting within the resized/re-orientated image such that the first frame 170 is clearly tilted due to the style selected but both first and second frames 170 and 180 respectively are clearly mismatched laterally and size wise to the second user image 120. Further, if the user views the frames and selects a different colour option this is not reflected within the displayed image. Hence, the user gets a poor image of the frames upon their face to select from and cannot view multiple frames concurrently. However, some retailers offer multiple frames whilst others allow the user to adjust the zoom and position of the glasses arbitrarily. In such instances the “TRY” feature adds little to the purchasing user's selection process as it reflects more on predetermined templates and/or user finessing templates than analysis and assessment of the user's face and frame options.

A: Background

The face can give a lot of clues about a person such as emotions, body language and identity. Moreover, in the fashion industry where it can be used to determine the most attractive hairstyle, makeup and eyewear for a specific person. In parallel within social and medical disciplines, computational disciplines have sought to quantify and automate the detection of salient facial features. For instance, some work focuses on quantifying the attractiveness of a person automatically based on a single photograph. Furthermore, applications in face detection, face feature extraction and authentication based on a single photograph has received a lot of attention. However, within embodiments of the invention the main focus is on the aesthetic correlation between the shape of the face and the shape of eyewear frames. The inventors have established a data-driven approach that has at its core a robust and fully automatic face and automatic frame shape extraction and classification engine.

While state of the art face extractors are very reliable to automatically detect the important features such as face boundary and salient points such as the eyes from a single photograph, face shape classification still remains a difficult problem. Many general shape classification methods have been proposed but these tend to work well if the shapes are significantly different to each other. However, in the case of faces, the shape variation from one category to another is often very subtle.

Furthermore, some face shapes cannot be classified as one shape as in fact they are better classified as a blend between two standard shapes. Accordingly, a tailored approach is required in order to differentiate the subtle characteristic of each shape category and to account for the blending of the shapes.

The first practical eyewear shape extraction method was introduced by Jing et al. in [29] and formulated the problem as an optimisation problem on a set of active contours using the edges detected within the image. However, only approximately 50% of the eyewear frames are well reconstructed and modifications improved the accuracy slightly by computing a probability that an edge is part of the frame. This probability being learned from a set of examples. The reliability is still not very high and this probability has to be learned from a large class of eyewear, which requires content updates whenever new glasses are designed. Several other methods have been at eyewear detection and eyewear removal from an image. However, these methods typically do not extract an accurate outline of the eyewear shape and thus are not suitable for the applications to which embodiments of the invention are directed. A purely geometric method that requires no a priori knowledge based on Delauney triangulation of the edges in the image offers promise for fully automated software systems but the results are not very robust or precise as usually these regions within images contain noise and outlier pixels, which can further down the pipeline affect the shape classification. More recently, a reconstruction method based on template matching of a database of preexisting shapes has been proposed. This is inadequate for our application as any new eyewear glass designs will have to be constantly introduced into the database.

The frame classification problem suffers from the same challenges as the face classification problem in that the shape changes between different classes are subtle, making it difficult to differentiate using a generic shape classification algorithm. Accordingly, a more accurate and robust method tailored for this specific problem is required. In order to achieve this the inventors chose a case based reasoning (CBR) framework approach that is suitable for both the face shape classification and eyewear frame shape classification. A CBR framework consists of a training set and a query set defined over a feature space endowed with a distance metric.

The classification of the elements of the solution set is assumed to be known and the problem is to find the classification of the elements in the query set. The classification of a query element is based on a nearest search in the training set. This framework is very efficient and scales well to large datasets making it particularly suitable for the classification problems according to embodiments of the invention.

A.1: Open Source Computer Vision

Open Source Computer Vision (OpenCV) is a library of programming functions aimed primarily at real-time computer vision and image processing applications originally developed by Intel. OpenCV is written in C++ and some of its application areas include 2D and 3D feature toolkits, facial recognition system, gesture recognition, motion tracking, and human computer interaction (HCI). For prototyping embodiments of the invention the inventors adopted OpenCV due to its acceptable efficiency and speed in C++ environments. Within the developments according to embodiments of the invention exploit OpenCV to address image edge detection, image contour recognition, fitting geometric shapes to sets of 2D points, approximating the area of non-regular convex shapes, calculating the convex hull of sets of points, and measuring the symmetry of closed polygons.

A.2: Edge Detection Algorithms

Edge detection refers to a set of mathematical methods which aim to identify points within a digital image at which the image brightness changes sharply or, more formally, has discontinuities. The points at which image brightness changes sharply are typically organized into a set of curved line segments termed edges. As such edge detection is a fundamental tool in image processing, machine vision and computer vision, particularly in the areas of feature detection and feature extraction. The purpose of detecting sharp changes in image brightness is to capture important events and changes in properties of the world. It can be shown that under rather general assumptions for an image formation model, discontinuities in image brightness are likely to correspond to one or more of discontinuities in depth, discontinuities in surface orientation, changes in material properties, and variations in scene illumination.

In the ideal case, the result of applying an edge detector to an image leads to a set of connected curves that indicate the boundaries of objects, the boundaries of surface markings as well as curves that correspond to discontinuities in surface orientation. Thus, applying an edge detection algorithm to an image may significantly reduce the amount of data to be processed and may therefore filter out information that may be regarded as less relevant, while preserving the important structural properties of an image. If the edge detection step is successful, the subsequent task of interpreting the information contents in the original image may therefore be substantially simplified.

However, it is not always possible to obtain such ideal edges from real life images of moderate complexity. Edges extracted from non-trivial images are often hampered by fragmentation, meaning that the edge curves are not connected, missing edge segments as well as false edges not corresponding to interesting phenomena in the image thereby complicating the subsequent task of interpreting the image data.

There are many methods for edge detection, but most of them can be grouped into two categories, search-based and zero-crossing based. The search-based methods detect edges by first computing a measure of edge strength, usually a first-order derivative expression such as the gradient magnitude, and then searching for local directional maxima of the gradient magnitude using a computed estimate of the local orientation of the edge, usually the gradient direction. The zero-crossing based methods search for zero crossings in a second-order derivative expression computed from the image in order to find edges, usually the zero-crossings of the Laplacian or the zero-crossings of a nonlinear differential expression. As a pre-processing step to edge detection, a smoothing stage, typically Gaussian smoothing, is almost always applied.

Amongst, the well-known edge detection algorithms are the Canny method which detects a wide range of edges in images, the Sobel method wherein the output would be an image which emphasizes edges and transitions, the Prewitt method where at each point in the image, the result of the Prewitt operator is either the corresponding gradient vector or the norm of this vector, and the Roberts method which approximates the gradient of an image through discrete differentiation which is achieved by computing the sum of the squares of the differences between diagonally adjacent pixels.

Within the method presented in respect of embodiments of the invention the Canny edge detection method has been used as part of the frame extraction mechanism. However, it would be evident that other methods may be employed without departing from the scope of the invention.

A.2.1: Canny Edge Detection

Canny's aim was to discover an optimal edge detection algorithm. Within the applications according to embodiments of the invention an “optimal” edge detector means one that has a low error rate, meaning good detection of only existent edges; good localization, such that the distance between edge pixels detected and real edge pixels is minimized; and minimal response, such that there is only one detected response per edge. To achieve this Canny used the calculus of variations which finds the function which optimizes a given functional. The optimal function in Canny's detector is described by the sum of four exponential terms, but it can be approximated by the first derivative of a Gaussian. Accordingly, Canny edge detection is a four step process:
A Gaussian blur is applied to clear any speckles and free the image of noise;
A gradient operator is applied for obtaining the gradients' intensity and direction;
Non-maximum suppression determines if the pixel is a better candidate for an edge than its neighbours; and
Hysteresis thresholding finds where edges begin and end.

voidCanny(InutArrayimage,OutputArrayedges,DoubleThreshold1,DoubleThreshold2,int ApertureSize=3,boolL2gradient=false) (1)

Within OpenCV, the Canny is developed and can be used by calling the method given by Equation (1) where image is a single-channel 8-bit input image, edges is the output edge map having same size and type as the image, threshold1 is a first threshold for the hysteresis procedure, threshold2 is a second threshold for the hysteresis procedure, apertureSize is the aperture size for the Sobel( ) operator and L2gradient is a flag indicating whether a more accurate L2norm or a default L1norm is to be used, these being given by Equations (2) and (3).

L2norm=\sqrt{(dI/dx)²+(dI/dy)²} when L2gradient=true (2)

L1norm=|dI/dx|+|dI/dy| when L2gradient=false (3)

The function finds edges in the input image and marks them in the output map edges using the Canny algorithm. The smallest value between threshold1 and threshold2 is used for edge linking. The largest value is used to find initial segments of strong edges. The output edge is used as the input array for contour detection procedure.

A2.2 Shape Contour Detection

A contour may be explained simply as a curve joining all the continuous points (along the boundary), having same color or intensity. Such contours are a useful tool for shape analysis, object detection, and object recognition. Within OpenCV the method given by Equation (4) calculates the contours of an input array, e.g. the image processed by the Canny edge detection algorithm. Within the method image is the source 8-bit single-channel image, contours is the detected contours, each stored as a vector of points, hierarchy is an optional output vector which contains information about the image topology and has as many elements as there are contours.

void[findContours(InputOutputArrayImage,OutputArrayofArraysContours,int(mode),int(method),PointOffset=Point( )) (4)

mode refers to the contour retrieval mode which can be:
CV RETR EXTERNAL: retrieves only the extreme outer contours;
CV RETR LIST: retrieves all of the contours without establishing any hierarchical relationships;
CV RETR CCOMP: retrieves all of the contours and organizes them into a two-level hierarchy; and
CV RETR TREE: retrieves all of the contours and reconstructs a full hierarchy of nested contours.

method refers to the contour approximation method which can be:
CV CHAIN APPROX NONE: stores absolutely all the contour points; and
CV CHAIN APPROX SIMPLE: compresses horizontal, vertical, and diagonal segments and leaves only their end points; and
CV CHAIN APPROX TC89 L1, CV CHAIN APPROX TC89 KCOS: applies one of the flavors of the Teh-Chin chain approximation algorithm.

Offset is an optional offset by which every contour point is shifted.

A.3: Classification Method

Embodiments of the invention exploit classification methods of faces and frame types into different categories. The inventors selected the “Case-Based Reasoning” (CBR) classification method to classify face and frame shapes. A CBR solver in essence solves new problems by adapting solutions that were used to solve old problems and can be summarized as having two phases, storing previous cases in memory and solving new problems where the later exploits a four step-process wherein these steps are:
1. Retrieve As per the problem definition, retrieve from memory cases that are relevant to solving it. A case consists of a problem, its solution and annotations about how the solution was derived.
2. Reuse After retrieving the best possible solution from the previous case, map the case to the problem definition. This may involve adapting the solution as needed to fit the new situation.
3. Revise Having mapped the previous solution to the problem, test the new solution in the real world and, if necessary, revise.
4. Retain After the solution has been successfully adapted to the problem definition, the resulting experience is stored as a new case in memory that can be used for future learning.

Advantages of CBR over other classification techniques include:
High flexibility as knowledge can be distributed between the four containers according to application needs and every container can hold the whole knowledge;
Focus on knowledge in the case base;
Knowledge in the case base can be updated and maintained very easily;
Reduces the knowledge acquisition effort;
Requires less maintenance effort;
Improve problem solving performance through reuse;
Improve over time and adapt to changes in the environment; and
High user acceptance.

A.4: Face Tracker

Detection of the face edge is a necessary step within embodiments of the invention. Within the prior art as noted supra there are many algorithms offering edge detection. However, based upon the mathematical model and calculations involved, the algorithm adopted by the inventors was the Gradient Edge Detection (GED) Predictor Template Algorithm (GED Algorithm), see for example [7]. The GED Algorithm uses 5 neighbouring pixels to determine local gradient and predict the current pixel value. These 5 adjacent pixels are A and D in the same row, E and B in the same column and C which is a diagonal pixel. The GED Algorithm uses fixed single direction, e.g. from left to right or from top to bottom, to analyze the image but it may not predict the proper pixel values. Accordingly, a multi-directional template of the GED Algorithm was employed with the image divided into 4 parts and each part is processed individually. This is because the central part of the image covers the most of the information about the picture and the regional characteristics and local gradient directions are mainly considered.

The GED Algorithm steps employed were follows:

1. Calculate the Local Gradients (Horizontal and Vertical) using Equations (5) and (6) respectively.

dh=|D−A|+|C−B|(HorizontalGradient) (5)

dv=|C−A|+|E−B|(VerticalGradient) (6)

2. Prediction Pixel Value is calculated using the following routine:

```
if (dv − dh > 80) then
      I′ = A
else
      if (dv − dh < −80) then
            I′ = B
      else
            I′ = [3(A + B)/2 + (C + D + E)/12]
      end
end
```

3. Calculate the Forecast Error Value as given by Equation (7).

E(I,J)=|I−I′| (7)

4. Determine Edges of the Image

To calculate the edges, a between-cluster variance method is used which follows the following steps:

| | |
|---|---|
| E(I, J) | gray value of the original image |
| r | separated threshold value between foreground |
| | and background |
| G1 ∈ E(I, J) ≤ T | foreground |
| G2 ∈ E(I, J) > T | background |
| Pr(r_{q}) = (n_{q}/n) | rate of pixels number in gray scale r_{q} for image |
| | pixels |
| (q = 0, 1, 2, . . . , L − 1) | |

When σ² value is maximum for some value of T, then T is the best segmentation threshold and edges of the image are identified as below:

```
if E(i, j) > r then
      Mark the Pixel as edge point
else
      Mark the Pixel as non-edge point
end
```

5. Apply Thinning Algorithm

Edge image pixel matrix (from previous step) contains multi-pixel wide edges. It has to be skeletonised to the single-pixel wide edge so that the contour points of the face can be determined. Table 1 below provides the terms used within the Edge Detection mechanism.

TABLE 1
Terms used in Edge Detection Mechanism

| Term/Equation | Definition |
|---|---|
| ${ω}_{0} = {\sum }_{q = 0}^{T - 1} {p}_{q} ( {r}_{q} )$ | Proportion of target pixels |
| ${ω}_{1} = {\sum }_{q = T}^{L - 1} {p}_{q} ( {r}_{q} ) = 1 - {ω}_{0}$ | Proportion of background pixels |
| $μ = {\sum }_{q = 0}^{L - 1} {qp}_{q} ( {r}_{q} )$ | Gray scale mean of entire image |
| ${μ}_{0} = {\sum }_{q = 0}^{T - 1} {qp}_{q} ( {r}_{q} ) \text{/} {ω}_{0}$ | Gray scale mean of target pixel (μ₀) |
| ${μ}_{1} = {\sum }_{q = 0}^{T - 1} {qp}_{q} ( {r}_{q} ) \text{/} {ω}_{1}$ | Gray scale mean of target pixel (μ₁) |
| σ² = ω₀(μ₀ − μ)² + | Need to take maximum of this value among all |
| ω₁(μ₁ − μ)² | to determine maximum threshold |

Following Thinning algorithm is applied to the edge image pixel matrix as:

(a) Create two matrices (Hₘ for horizontal scan matrix and Vₘ for vertical scan matrix) with all default values set to 1.

(b) Scan the edge image pixel matrix horizontally and check for any transition between pixels, such as 0 to 1 or 1 to 0. If found, then keep the tag the value of 0 to 0 in new matrix. Remaining values are left to default 1.

(c) Repeat the same procedure from previous step for vertical scan (Vₘ).

(d) Finally, by simple “and” logical operation, both Hₘ and Vₘ are combined together to give the final face edge matrix.

Accordingly, embodiments of the invention exploit a state of the art face tracker which tracks the face with all of the above rules and definitions. The output of the face tracker algorithm then provides the input to the inventor's procedures.

B: Eyewear Recommendation System

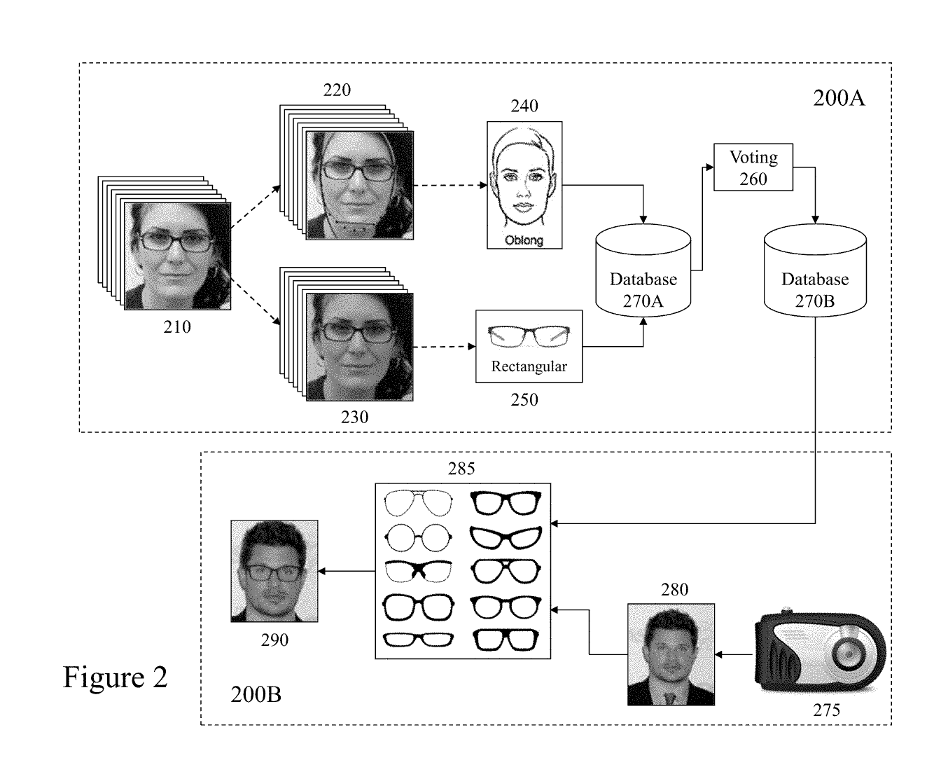

The embodiments of the invention presented here are based upon dividing the requirement for establishing an eyewear recommendation into two parts. Firstly, the user's face is classified by the classification procedures and secondly the recommendation system provides recommendations. Referring to FIG. 2 there is depicted schematically an overview of the overall system wherein first portion 200A relates to the data collection pipeline and 200B the recommendation pipeline.

For each image, the system undertakes Face Shape Recognition and Frame Shape Recognition. Each of these algorithms contains pre-processing followed by feature extraction and classification phases. Referring to first portion 200A an image database 210 of subjects wearing eyeglasses are presented to the system as input. Accordingly, the geometric features 220 are extracted from the faces and automatic frame shapes 230 are extracted based on these processes. Subsequently, facial classification 240 and frame shape classification 250 are executed and the results stored within a first database 270A. Now, having mechanisms to recognise the shape of face and frame of images automatically, we can enable the system to produce data-driven surveys in order to rank the most fitted face/frame combinations base on users' perception. Accordingly, such a survey or surveys may be executed by pulling combinations of faces and frames from the first database 270A, obtaining user's votes through a variety of mechanisms including crowdsourcing, social media, dedicated web marketing, dedicated surveys, etc. Alternatively, within other embodiments of the invention a purchase by a user may constitute a vote, i.e. the classifications are modified as eyewear frames are purchased. Previous eyewear frames browsed and/or looked at may also be indications of user preferences. Accordingly, the ratings of these images from the survey(s) are stored together with the face and eyewear classifications within the second database 270B from which we can extract the most popular combinations. It would be evident that surveys and their results may be generated for a range of scenarios such that popular combinations are generated and stored for a variety of demographic and/or socio-economic and/or geographical scenarios. Accordingly, the voting process 260 may be performed in different parts of a single country or region to capture variations within the country and/or region (e.g. California versus Texas, Bavaria versus Schleswig-Holstein, 18-25-year-old Italian men, 55-70-year-old North American women, etc.)

Second portion 200B now addresses the eyewear recommendation system. When an image 275 is provided of a user without glasses then face shape detection is performed on the image and based upon the results from this a recommendation is made from different types of the glasses available in the system 285. The user is presented with a frame of the recommended type overlapped to their face wherein as their facial profile has been analysed the frame can be aligned and/or scaled relative to their facial image or vice-versa. Optionally, the user may be presented with a couple of recommendations which are provided through a process that is seamless or frictionless.

B.1 Face Shape Extraction and Classification

Within the prior art face shape as a factor in fashion and psychology has received significant attention. Psychologists and stylists provide descriptions about each pattern of face shapes in order to provide people with suggestions about their face characteristics and style. Moreover, some online resources, e.g. the Frames Direct website depicted in respect of FIG. 1, provide basic recommendations by allocating different styles to particular face shapes. However, generally such recommendations are not really recommendations but simple filters designed to reduce the number of options. For example, on Dec. 16, 2014 there were 4713 frames for women. Selecting face type provided 2532, 2381, 2166, 3592, 2669, 2266, and 2188 frames for each of diamond, heart, oblong, oval, round, square and triangle face shapes as options. Other systems may only provide 3 or 4 facial options.

It becomes more difficult for the user to operate such online resources, if user is not aware of his/her own face shape, has a distorted perception of their face, or has a face with asymmetry best characterized by multiple face shapes. Accordingly, it is to remove this step that the inventors have established a new approach to determining face shapes such that all the user has to do is provide an image to the Face Shape Recognition System (FSRS) which then provides them with their face shape such that this analysis and determination can then be stored relative to a profile of the user within online resource(s) for subsequent recommendations of eyewear as well as other items relating to the user's upper body where the head shape impacts the suitability of different options.

Within the embodiments of the invention described below various efficient and reliable algorithms are used to compute face shapes by comparing selected facial features and their respective inclination of face edges with variants of face shapes in a facial database. Whilst initial embodiments of the FSRS work most efficiently with images with simple background it would be obvious to one skilled in the art that other image processing techniques known within the prior art may be employed to remove background image content as well as process the image for enhanced pattern recognition using the FSRS algorithms. The FSRS employs a typical sequence of phases for pattern recognition wherein data sets are required for building categories and to compare similarities between the test data and each category. Accordingly input data is passing through a pre-processing stage of the stored raw data wherein a sequence of data pre-processing operations are applied to the images in order to put them into a suitable format ready for feature extraction. After this each raw data item within the data sets is transformed into a set of features, and the classifier is mainly trained on these feature representations. When a query is received similar data pre-processing is carried out followed by the same sequence of operations and then features are added into the trained classifier. The output of the classifier will be the optimal class label (sometimes with the classification accuracy) or a rejection note (return to manual classification).

Many techniques for the detection of facial feature points exist within the prior art including approaches based upon luminance, chrominance, facial geometry and symmetry. The detection and localization of a face and of its features are instrumental in the successful performance of subsequent tasks within related computer vision applications. Many high-level vision applications such as facial feature tracking, facial modeling and animation, facial expression analysis, and face recognition, require reliable feature extraction.

The proposed method employed by the inventors utilizes an analysis of different face shapes based on the boundary points across the edges of the face. The inventors have established that such an algorithm yields good results using a subset of feature points than many other typical applications. The image database used for these experiments was an adequate number of images retrieved from online resources although it would be evident that other databases may be employed such as social media profiles, Government photo-identity databases, etc. A subset of these images were chosen to reduce problems associated with lighting, facial expressions and facial details although it would be evident that embodiments of the invention may be extended to exploit image processing/filtering techniques as described supra with respect to removing background content etc. An initial training data set of over 300 different face shapes were employed that were recognized by domain experts i.e. Fashion Designers, Hair Stylists, etc. In testing data, the inventors took 100 new face shapes and 50 randomly selected from training data.

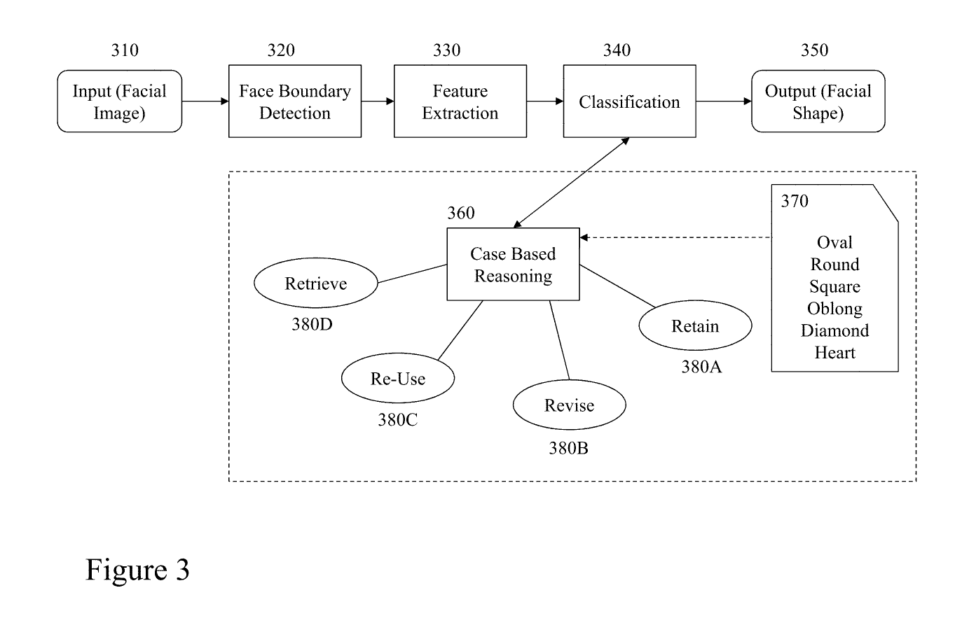

Embodiments of the invention implemented by the inventors for face shape recognition as a method to identify a person through a photograph of their face employs four modules. The first module in face recognition processing is known as face detection which provides an initial estimate of the location and scale of specified boundary points on the face. The second module in the face recognition processing is face point creation wherein accurate localization is required. The third module for processing is feature extraction, where we seek to extract effective information that will potentially distinguish faces of different persons wherein it is important in this module to obtain stable geometrical representations of the extracted features. In the final module, feature matching, the extracted feature vectors of a particular image are compared to the face images stored in the database to determine the classification to apply to the face in the image. Referring to FIG. 3 this process flow of an FSRS system according to an embodiment of the invention is outlined wherein the steps presented are:
Step 310 Image is input;
Step 320 Face boundary detection;
Step 330 Feature extraction;
Step 340 Classification; and
Step 350 Output facial shape.

As depicted the classification step 340 employs a Case Based Reasoning (CBR) 360 classification methodology comprising steps of retrieve 380A, re-use 380B, revise 380C, and retain 380D wherein classifications 370 for the output are defined as being Oval, Round, Square, Oblong, Diamond and Heart. It would be evident other classifications may be employed and that the number of classifications may also be adjusted within other embodiments of the invention. For example, linear combinations of shapes may form classifications, such as 80% oval and 20% heart or 60% square and 40% diamond, for example

B.1.A Feature Extraction

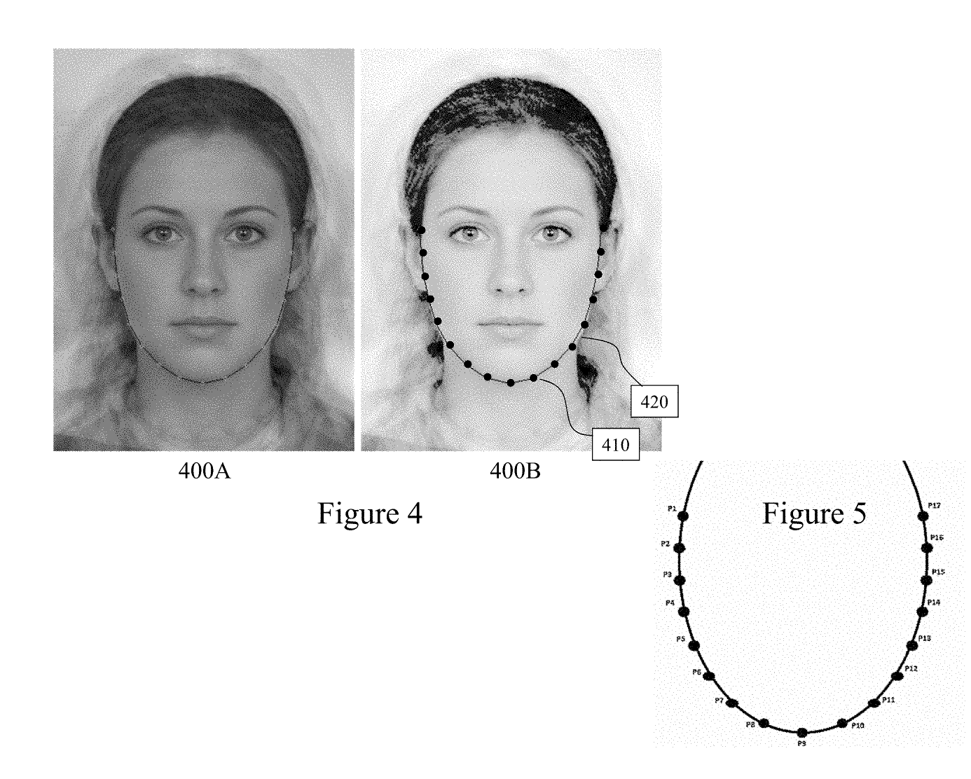

Based on the algorithms and procedures described supra in respect of Section A.4 Face Tracker then seventeen (17) points were extracted based upon approximation and the use of natural symmetry of the face, which help to identify the features of the face. It would be evident that other numbers of points may be employed. Referring to FIG. 4 there is depicted an image of a face after processing in first image 400A. Second image 400B has been digitally processed using a graphics engine to increase contrast and overlaid with markers allowing the feature points 410 to be viewed more clearly along with the symmetric boundary 420 is depicted with blue curved line. FIG. 5 shows the resulting feature points 410 and boundary 420 absent the image indicating their numbering and position.

B.1.B Face Shape Classification

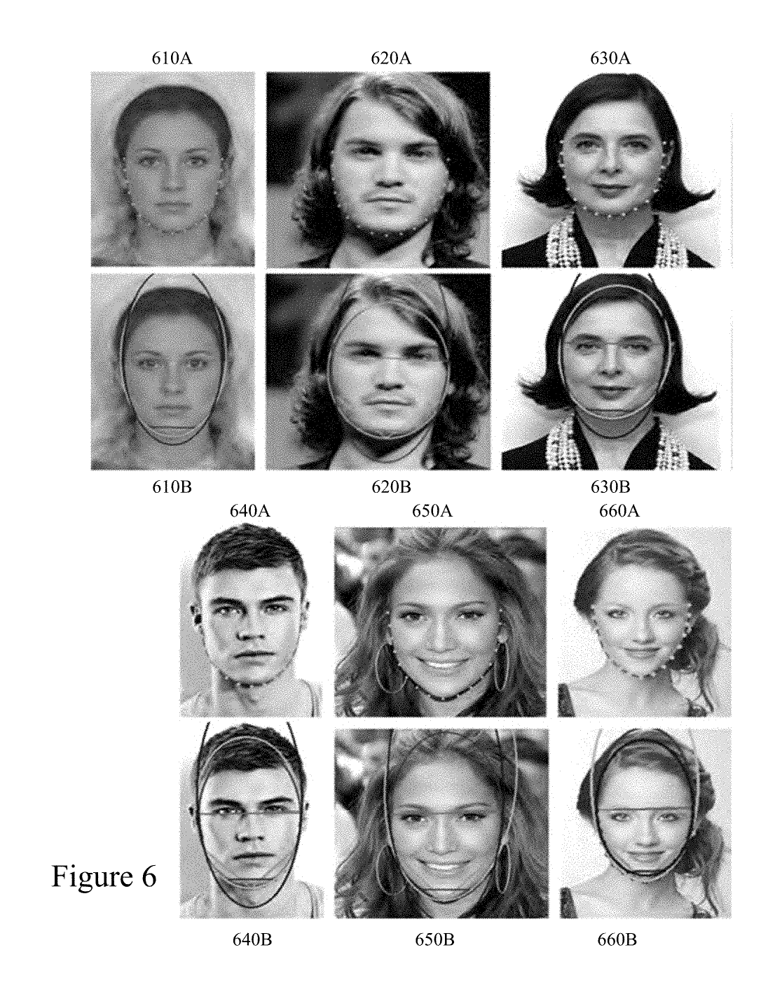

Referring to FIG. 6 there are depicted representative images of the six facial types employed within the classifications of the FSRS processes according to embodiments of the invention by the inventors. This classification procedure represents the third step 340 in FSRS process flow depicted in FIG. 3. Accordingly, within FIG. 6 there are depicted first to sixth images 610A to 660A representing oval, round, square, oblong, diamond, and heart face types with their associated extracted geometric feature points as discussed supra and as would be generated by a feature extraction process representing the second step 330 in FSRS process flow depicted in FIG. 3. Also depicted are seventh to twelfth images 610B to 660B representing the same 6 individuals but now their image has been overlaid with generated geometric features exploiting the 17 extracted feature points depicted in first to sixth images 610A to 660A respectively. For each face 6 geometric features are depicted, these being:
First ellipse that best fits at the boundary points;
Second ellipse that best fits the chin points;
Third ellipse that best fits the cheek boundary points;
First line being diagonal lines on lower face;
Second line being jaw line; and
Third line being the eye line.

Based upon the detected 17 points from the face the inventors extract different features. For comparisons within the embodiments of the invention discussed below 8 different face features are considered. Three of these are captured by generating ellipses from different points of the face and others are determined by calculating distances. The 6 main elements of face utilized to distinguish different face shapes are:

1. Ellipse Generation. By drawing ellipses with face points, wherein, initially, three ellipses are drawn considering the different facial points:

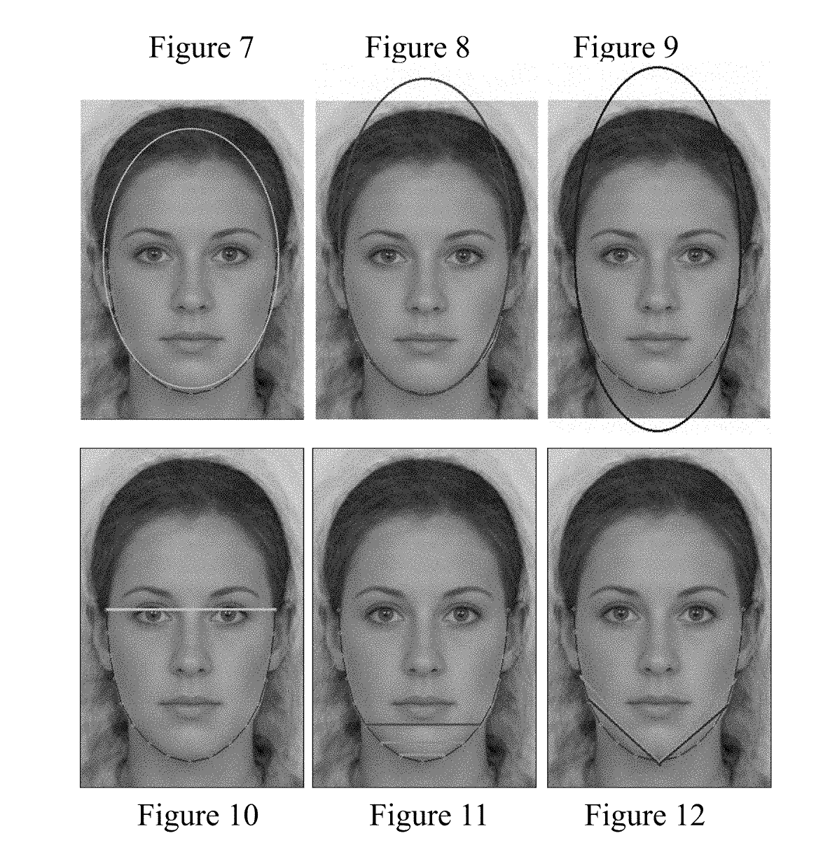

(a) A first ellipse fitted such that it accommodates most of the feature points. This is depicted in FIG. 7 for a user, the same user as first and seventh images 610A and 610B respectively in FIG. 6 and FIG. 4. This ellipse is used to derive the height of the individual's face.

(b) A second ellipse fitted such that it accommodates only the chin points. This is depicted in FIG. 8. This ellipse is used to identify the chin shape as being pointed (for heart shape) or round (for oblong shape) or other (for square shape);

(c) A third ellipse that considers the remaining points. This is depicted in FIG. 9 and is used to identify if the width of the face is same at eye line, cheekbone and jaw line which is beneficial in identifying if the facial shape is oblong or square.

2. Distances. By taking the distances of facial points from drawn ellipses in previous step (1) where these are calculated from the respective ellipse to recognise which type of ellipse covers maximum points. Moreover, a threshold value is set for the distances during training phase. For example, consider the ellipse that covers chin points. If the chin is pointed, then the distances of the chin points from ellipse will be more than the threshold value such that these type of faces can be categorised in heart or diamond face shape. However, if the distances are less than threshold value, then face may be categorized in round or oval face shape.

3. Eye Line Length. Eye Line Length is calculated by joining P1 and P17. This property length is compared with cheek bone line and jaw line. It will help to determine if these lengths are equal for oval or round faces, or differ substantially as with heart and diamond face shape as evident in FIG. 10.

4. Jaw Line Length. Calculation of Jaw line may not be accurate because few face shapes have explicitly defined jaw lines such as round or oval. Therefore, the Jaw Line is defined by averaging 3 different lines that join face points P6-P12, P7-P11, and P8-P10 as depicted in FIG. 11.

5. Symmetry Lines. A series of diagonal line lengths that connect jaw points with face symmetry point P9. Four diagonal lines are drawn from points, P4, P5, P13, P14 to point P9 and the lengths of these lines are used to decide if the face is elongated. Moreover, these lines are used to calculate distances of the remaining face points, as explained in the next step.

6. Distances of Points from Diagonal Lines. Although the distances from the different ellipses generated in step (1) above are compared to identify the face shapes, results will not be accurate as it may miss the angles present at the jaw line. In order to overcome this limitation, the inventors exploit the diagonal lines generated in step (5) in order to calculate the distances of the face points near the jaw. These distances more accurately determine if the face shape is wider near the jaw as depicted in FIG. 12.

As noted previously the number of extracted feature points may be varied without departing from the scope of the invention. In such circumstances the face points employed for distances and/or ellipses may be modified accordingly.

Normalization:

As the user may input an image of any size the extracted image features may not be directly compared otherwise the results will not be accurate. Although the image is normalized to a specific fixed sized matrix, it cannot avoid the errors with the images having zooming effects (either zoomed in or zoomed out). In order to avoid such type of discrepancies, the natural symmetry of the face is utilized again to determine special features. Such features are described in Table 2.

TABLE 2
FSRS Normalized Features

| | Feature | Explanation |
|---|---|---|
| 1 | Height (all)/Width (all) | Height and width of ellipse drawn |
| | | from all facial points |
| 2 | Height (chin)/Width (chin) | Height and width of ellipse drawn |
| | | from chin points |
| 3 | Height (other)/Width (other) | Height and width of ellipse drawn |
| | | from face side points |
| 4 | Distance (all)/Width (all) | Distance of each facial point from |
| 5 | Distance (chin)/Width (chin) | respective ellipses drawn. |
| 6 | Distance (other)/Width (other) | |
| 7 | Eye-line/Jaw line | Lines extracted from feature |
| | | extraction steps 3 and 4. |
| 8 | Distance from bottom points to | Lines extracted from feature |
| | diagonal lines/Width (all) | extraction step 6. |

Classification:

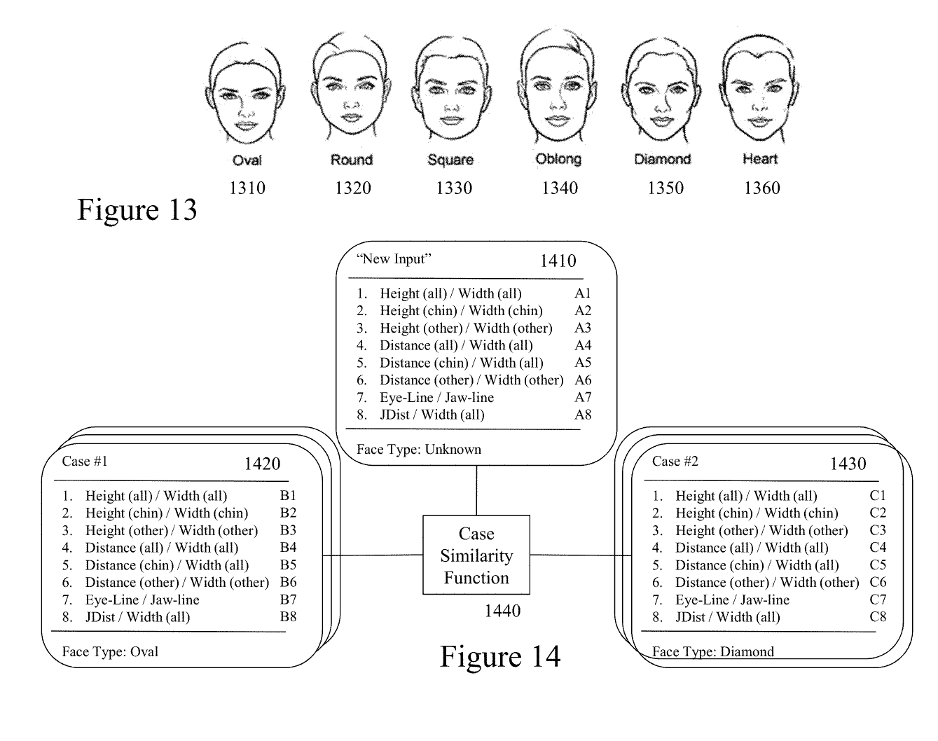

Within the FSRS according to embodiments of the invention six different types of face shapes are considered for identification. However, in other embodiments of the invention more or less types of face shapes may be employed within the identification process. Within the current embodiment these are Heart, Oblong, Oval, Diamond, Square and Round as depicted in FIG. 13. Facial properties for each shape are summarized in Table 3. The variables employed within these determinations are listed Table 4.

TABLE 3
Facial Shape Characteristics and Definitions

| | | Features in Mathematical |
|---|---|---|
| Type | Facial Features | Form |
| Oblong | Narrow shape that's longer | 1. Lₕ > L_{cb} |
| (Rect- | than it is wide. Angular features | 2. L_{f} ≈ L_{cb} ≈ Lⱼ |
| angle) | with high cheekbones, a longer | |
| | nose, and tall forehead. | |
| Diamond | Narrow at the eye line and the | 1. Lₕ = L_{cb} |
| | jaw line with a small forehead | 2. L_{cb} >> L_{f} and L_{cb} >> Lⱼ |
| | and chin. Angular features with | |
| | dramatic cheekbones. | |
| Heart | Broad forehead and wide | 1. L_{f} >> Lⱼ |
| | cheekbones that narrow to a | 2. L_{cb} >> Lⱼ |
| | small chin. | |
| Oval | Mostly balanced proportions. | 1. Lₕ > L_{cb} |
| | Chin is slightly narrower | 2. Lⱼ ≈ L_{f} |
| | than forehead and cheekbones | 3. L_{cb} > Lⱼ and L_{cb} > L_{f} |
| | are high. | |
| Round | Full cheeks, rounded chin with | 1. Lₕ = L_{cb} |
| | few angles. Width and length are | 2. L_{f} ≈ L_{cb} ≈ Lⱼ |
| | in same proportions. | |
| Square | Angular face with a strong jaw | 1. Lₕ ≈ L_{cb} |
| | line, broad forehead and square | 2. L_{f} ≈ L_{cb} ≈ Lⱼ |
| | chin. Proportional length and | |
| | width. | |

TABLE 4
Facial Comparison Variables

| Symbol | Feature |
|---|---|
| Lₕ | Height of Face |
| L_{cb} | Cheek Bone Length |
| Lⱼ | Jaw Length |
| L_{f} | Forehead Length |

Once all features have been extracted then the next step is to perform classification based on the retrieved features. The main purpose of the classification is to assign each point in the space with a class label. On the basis of a training set of data containing several observations, we identify to which of a set of categories a new observation belongs. The term “classifier” is an algorithm that implements a classification and a variety of classification methods can be applied depends on the problem definition. Based on the features extracted for the Face Shape recognition, we have used as discussed supra CBR as the classification method to classify face shape into different categories. It would be evident that within other embodiments of the invention that other classification methods may be employed. Referring to FIG. 14 there is depicted an exemplary scenario of CBR for FSRS.

Accordingly, within an embodiment of the invention the inventors defined the distance with the CBR as that given by Equation (8) where T is the feature vector extracted from using the test image, F^{k} is the feature vector of the k's element of the training images set, the subscript i denotes the components of the 8 dimensional feature vector and w is a weight associated to each of the features in order to compensate for the relative magnitude and importance of each feature. These weights were determined experimentally and were set only once. These weights being (1.2, 1.0, 1.0, 1.2, 1.1, 1.2, 1.1, 1.1)^{T}.

$$d ( T , {F}^{k} ) = {\sum }_{i = 1}^{8} {w}_{i} ( {T}_{i} - {F}_{i}^{k} ) \qquad ( 8 )$$

However, in the training only the dominant face shape was considered. Within the training process the inventors employed a set of 100 images extracted from the Internet and evaluated the accuracy of the classification process upon a different set of 300 pictures and these are presented below in respect of Section 4 Results.

B.2 Frame Shape Extraction and Classification

In common with the face shape recognition system presented supra in Section B.1 then the frame shape classification method consists of four steps. First, the polygonal shape of the frame is extracted from the image. Second, key geometric features tailored to differentiate between the various frame shapes are computed from the polygonal shape. Next these geometric features are converted into a feature vector that can be used within a CBR framework. The CBR framework is similarly trained on a set of known frame shapes and, finally, a query image is classified based on a nearest search on the elements of the training set. Whilst CBR classification was implemented essentially identically for both face and frame there are some differences with respect to their structure and within this section those differences with respect to the Frame Shape Extraction and Classification are reviewed.

B.2.1 Eyewear Frame Extraction

It would be evident that to be able to classify eyewear the main parts of the frame should be extracted, undoubtedly. Since, generally, an image of a person wearing the glasses is provided to the system as its input then there could be significant noise within the eyewear frame extraction process arising from aspects such as the person's facial properties, background, and lighting, for example. Hence, a reliable algorithm should be employed to provide reduced sensitivity to these noise sources. Within the embodiments of the invention presented here the inventors employed a combination of Edge Detection and Symmetry concepts to achieve this. The steps for Interior Frame Extraction employed are as follows:

1. Image Preprocessing
(a) Convert the image to grayscale format, for example using CV_BGR2GRAY of OpenCV.
(b) Smooth the image, for example using the blur function of OpenCV wherein each output pixel is the mean of its kernel neighbors where they all contribute with equal weights as given by Equation (9) where ksize is the blurring kernel size, and width and height calculated from image dimensions

$$K = \frac{1}{ksize \cdot width * ksize \cdot height} [ \begin{matrix}1 & 1 & … & 1 \\ 1 & 1 & … & 1 \\ 1 & 1 & … & 1 \\ 1 & 1 & … & 1\end{matrix} ] \qquad ( 9 )$$

2. Augmented Polygon Extraction
(a) Use a Canny algorithm to find the edges of the grayscale image with a threshold.
(b) Find contours on Canny results.
(c) Find symmetry line of the image.
(d) Contour Reduction.

3. Symmetric Contours Selection using a defined threshold based on reflection of each one using a symmetry line.

4. Calculate Convex Hulls of symmetric contours.

5. Frame Polygon Selection Procedure
(a) Check intersections.
(b) Fit ellipse to each convex hull.
(c) Calculate fitted oval area and convex hull area.
(d) Rank the convex hulls based on fitted oval area, convex hull area and number of intersections.
(e) Select the highest rank polygon

6. If there exists a convex hull which satisfies the condition, program is converged otherwise return to step 2 and repeat with a lower threshold.

Accordingly, it would be evident that the image preprocessing step prepares image for the next stages. For example, converting to grayscale, the noise within the image is reduced considerably, and smoothing the image leads to longer and more continuous contours. Within the augmented polygon extraction step the aim is to retrieve the smallest set of contours which contain the eyeframe polygon. However, it must also be borne in mind that the glasses are located around the eyes of the user. During contour detection, as a consequence, nested contours may be selected as the output, e.g. eye, eyelashes and eyewear frames, and accordingly, in order to prevent this, the inventors exploit CV_RETR_EXTERNAL in order to select only the outer contours. The contour method is CV_CHAIN_APPROX—NONE as then we can have all the contours for the next steps to have the actual frame extracted.

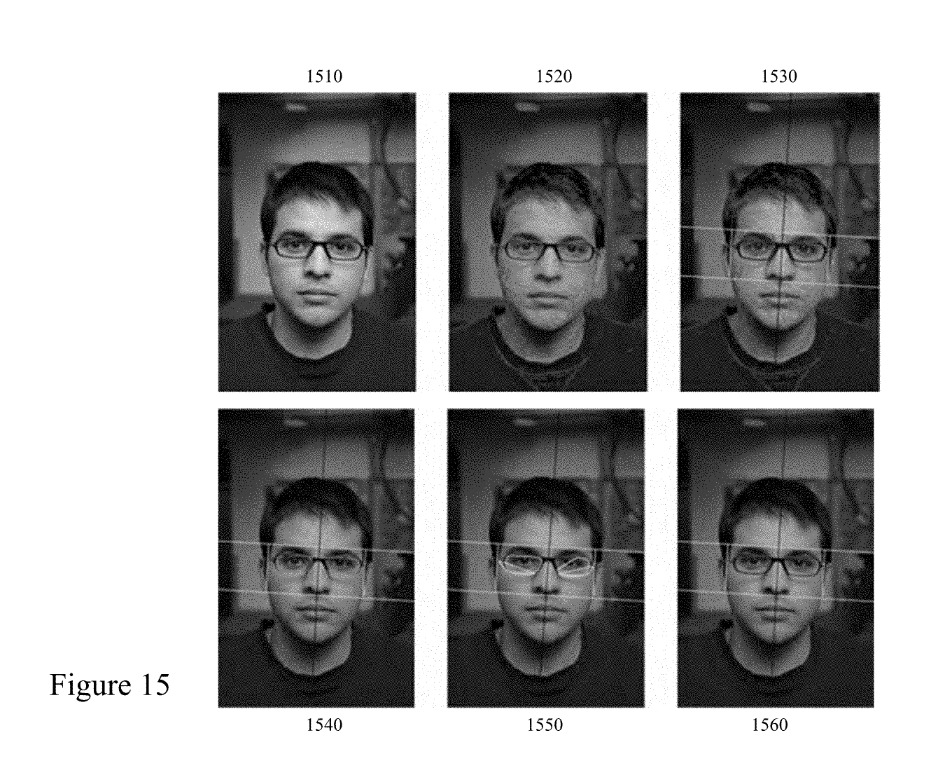

After finding the contours from the Canny detection results, the symmetry line of the image is calculated automatically based on the face size and angle in Stage 2(c) by using the face tracker described supra in respect of Section A.4. During execution of Stage 2(d) the contours around the eyeframes area would be kept in order to reduce the time and space complexity of the calculations. The box area is depicted in FIG. 15 within third to sixth images 1530 to 1560 respectively. It would be evident that the symmetry of the face and glasses are amongst the most distinguishing properties of the images and accordingly symmetric contours would be retrieved in stage 3 of the eyewear frame extraction algorithm. Then in stage 4 the convex hulls are calculated for all remaining contours that have closed polygons, by calling the OpenCV convex hull method. These functions find the convex hull of a 2D point set using Sklansky's algorithm that has O(N log N) complexity in the current implementation according to an embodiment of the invention.

Subsequently, to filter and select around the user's eyes these convex hulls, in step 4, the intersections of closed polygons and lines around the eyes will be calculated and the polygons with largest numbers of intersections would be stored for next processes. The frame polygon selection procedure is the mechanism that determines the exact frame polygon between those remaining. This in Step 5(a) calculates the number of intersections between the polygon and 6 lines which are drawn from the eyebrows, nose and lips to the center of eyes on the assumption that the frame polygon is surrounded on that area. Then in Step 5(b) the fitted oval is calculated for all remaining convex hull areas. Afterwards, the extraction of exact frame polygon is undertaken based on oval area, convex hull area, and number of intersections which are the thresholds based on possible size and geometry of frames. If the conditions are satisfied, the algorithm converged. Otherwise, the threshold of Canny algorithm will be changed and all steps (2) through (6) are executed with the new threshold.

The steps of frame extraction process are depicted in FIG. 15. To extract the polygonal shape of the frame reliably the inventors rely upon three important factors: the frame shape is a closed polygon, it is nearly always convex and symmetric for the right and left eye. First the contours are extracted from the image at different threshold levels using the Canny algorithm as the edge detector. For clarity only one level is shown in the second image 1520 for the original image 1510. Next, the face boundary line is computed using a state of the art face tracker followed by the eye region, which is depicted as the horizontal lines and short vertical lines in third image 1530 and the symmetry line which is evident vertically from the bottom to top of the third image 1530. Only those contours that intersect the eye region are kept, depicted as darker lines within the eye region in third image 1530. These contours are further refined by selecting only those that have a symmetric pair, yielding contours depicted in fourth image 1540. Symmetry is achieved if more than 50% of the points have a corresponding symmetric pair on the paired curve, within some predetermined image dimension, e.g. 5×5 pixels. Convex hulls are computed on the remaining polygons as depicted in fifth image 1550 and the candidates for the final polygon that approximates the frame shape. In order to avoid degenerate cases such as the triangular polygons fifth image 1550 constraints are placed on both the size of the polygon, e.g. more than 20% of the eye region, as well as its roundness, the area of the polygon should be at least 80% of the area of the best fitting ellipse. If more than one candidate exists, the largest one is selected. If no candidates exist, the edge detection threshold is decreased and the process repeated.

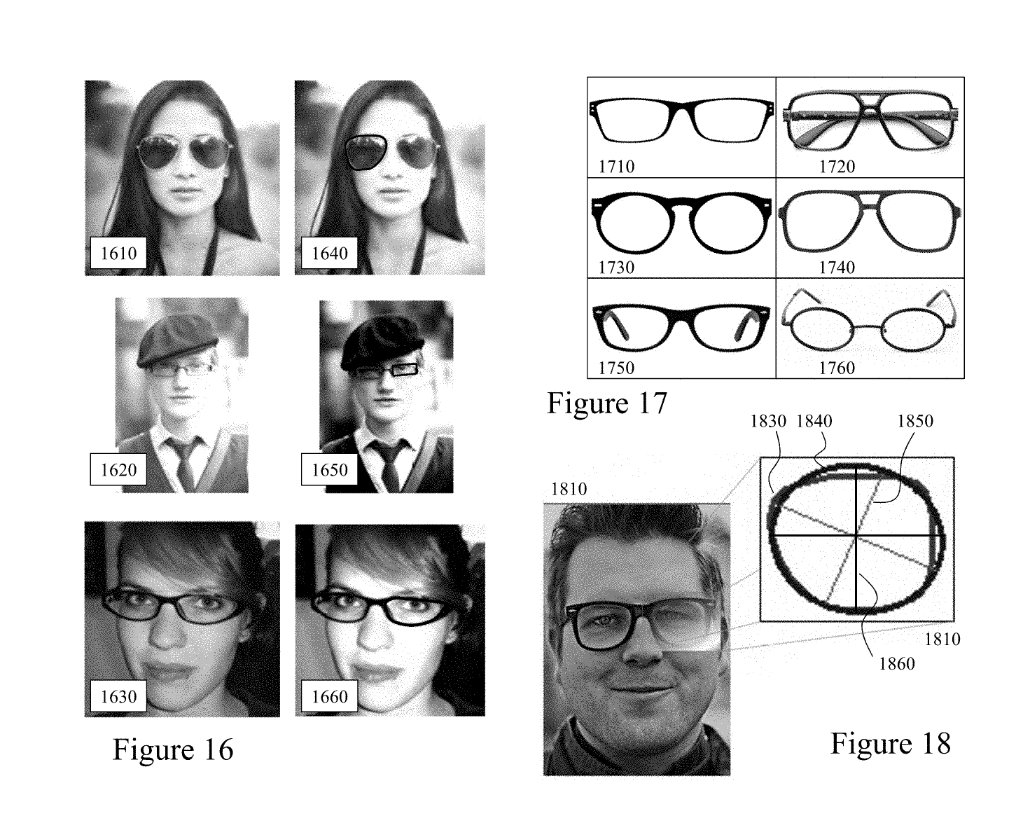

As evident from FIG. 16 this extraction mechanism works even on difficult input images such as sunglasses with reflection (first and fourth images 1610 and 1640), partially occluded faces and thin metallic frames (second and fifth images 1620 and 1650), and subjects with significant pose rotation (third and sixth images 1630 and 1660). In each instance the left image is the raw input and the right image the processed data with the derived frame outline overlaid to the original image.

B.2.2 Frame Classification

By considering commercial eyeframe retailers the inventors identified the six most common and standard classes of eyeframes available. These are depicted in FIG. 17 by first to sixth images 1710 to 1760 which relate to rectangular, square, round, “aviator”, “wayfarer” and oval eyewear frames. It would be evident that the embodiments of the invention presented here may be exploited with varying numbers of classes of eyeframes. A key distinctive features between the frame shape classes is the “roundness” of the shape, the orientation of the main axis, the size and the degree of symmetry with respect to the principle axis. Therefore, within the current embodiments the only geometric feature extracted is the best fitting ellipse, depicted by ellipse 1840 in FIG. 18 of the frame polygon 1830. Also depicted are the principle axes of the frame polygon 1830 showing the degree of rotation of the frame polygon 1830 relative to the X and Y axes. Accordingly, the features used in frame extraction were:

1. Frame fitted oval occupancy.

2. Frame fitted oval height/width.

3. Frame fitted oval angle.

4. Distance from frame convex hull to frame fitted oval.

5. Symmetry of the frame fitted oval.

FIG. 18 illustrates these features in a “wayfarer” frame 1740. As shown, the main component is the fitted ellipse of the convex hull polygon extracted. The occupancy of the ellipse in normalized by the face parameter to have the relevant size of the eyeframes. Based upon the analysis perform eyewear frames such as oval and rectangular do not have significant angle to the face, whilst “wayfarer” and “aviator” frames have significant angle. Accordingly, the fitted ellipse angle can be employed to approximate the degree between image and eyewear frame axis. In order to recognize round and angular frames, it is necessary to have the distance from the fitted ellipse to the extracted polygon. For this ellipse angle, because of probable rotation of the face, the correlative angle would be calculated. Further, in FIG. 18, the significant space between the eyewear frame and fitted ellipse polygons further differentiates non-circular/non-elliptical eyewear frames.

Additionally, the symmetry of the fitted ellipse is important in order to differentiate symmetric frames like oblong and non-symmetric frames like “aviator”. The symmetry factor of each polygon was calculated within the embodiments of the invention by realizing the distance from the center of mass and center of the window of the polygon. Within the context of the six eyewear frame classes discussed with respect to embodiments of the invention then these results obtained by the inventors demonstrate that these aforementioned features are sufficient to have an accurate frame recognition process. However, it would be evident that other features may be considered and employed without departing from the scope of the invention.

Classification:

Within the eyewear frame classification according to the results presented within this specification six different types of frame shapes were considered for identification, namely Aviator, Oblong, Oval, Wayfarer, Square and Round. The facial properties for each shape are summarized in Table 5 and the variable employed listed in Table 6.

TABLE 5
Facial Shape Characteristics and Definitions

| | | Features in Mathematical | |
|---|---|---|---|
| Type | Facial Features | Form | |
| Oval | Mostly balanced (symmetric) | 1. EHW < 1 | 3. E_{SYM} = 1 |
| | proportions with a larger width | 2. EA ≈ 0 | 4. ED ≈ 0 |
| | than height. Ellipse angle about | | |
| | zero. | | |
| Round | Completely symmetric proportions | 1. EHW = 1 | 3. ED ≈ 0 |
| | with equal width and height. | 2. E_{SYM} = 1 | |
| Square | Completely symmetric proportions | 1. EHW = 1 | 3. ED >> 0 |
| | with equal width and height. The | 2. E_{SYM} = 1 | |
| | distance to the ellipse is | | |
| | distinguishable. | | |
| Rectan- | Mostly balanced (symmetric) | 1. EHW = l | 3. E_{SYM} = 1 |
| gular | proportions with a larger width | 2. EA ≈ 0 | 4. ED >> 0 |
| | than height. Ellipse angle about | | |
| | zero. The distance to ellipse is | | |
| | distinguishable. | | |
| Aviator | The size of the glasses and the | 1. ES >> 0 | 3. E_{SYM} ≈ 0 |
| | ellipse angle are recognizable. | 2. EA >> 0 | |
| | The symmetry is about zero. | | |
| Way- | The size of the glasses and the | 1. ES >> 0 | 3. E_{SYM} ≈ 0 |
| farer | ellipse angle are recognizable. | 2. EA >> 0 | 4. ED >> 0 |
| | The symmetry is about zero. The | | |
| | distance to ellipse is more than | | |
| | Aviator frames. | | |

TABLE 6
Eyewear Frame Comparison Variables

| Symbol | Feature |
|---|---|
| ES | Ellipse Size |
| EHW | Ellipse Height/Width |
| EA | Ellipse Angle |
| ED | Distance to Ellipse |
| E_{SYM} | Ellipse Symmetry |

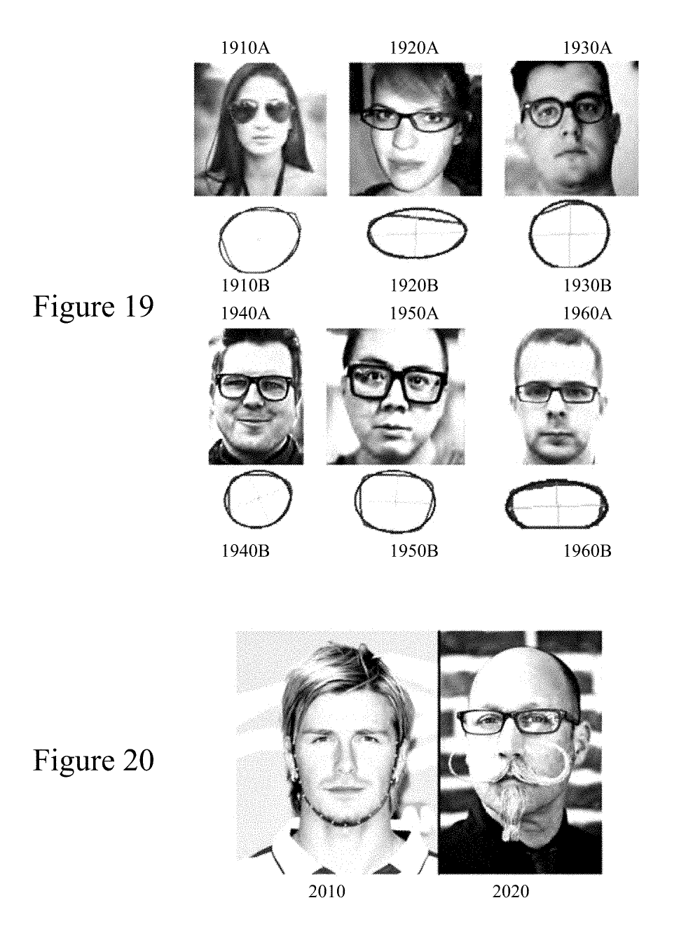

As mentioned supra the classification aspects of both face and eyewear frame follow the CBR model with different number of elements and learning samples. Referring to FIG. 19 there are depicted first to sixth images 1910A to 1960A for eyewear frames extracted of the different classes with their associated source images whilst seventh to twelve images 1910B to 1960B depicted the corresponding fitted ellipse for each. The frames in first to sixth images 1910A to 1960A being Aviator, Oval, Round, Rectangular, Square and Wayfarer. Using the best fitting ellipse, a 5-dimensional feature vector F is computed consisting of the following elements: the ratio between the height and the width of the best fitting ellipse, the tilt angle of the best fitting ellipse, the area of the shape polygon as a fraction of the eye region, the average distance from the shape polygon to the ellipse and the distance between the centre of mass of the polygon and the ellipse centre. Accordingly, the distance function (8) becomes that given in Equation (9) where T is the feature vector extracted from using the test image, F^{k} is the feature vector of the k's element of the training images set, the subscript i denotes the components of the 5 dimensional feature vector and wᵢ is a weight associated to each of the features in order to compensate for the relative magnitude and importance of each feature. These feature weights were determined experimentally, were set only once, and being (1.0, 1.2, 1.1, 1.2, 1.0)^{T}.

$$d ( T , {F}^{k} ) = {\sum }_{i = 1}^{5} {w}_{i} ( {T}_{i} - {F}_{i}^{k} ) \qquad ( 9 )$$

One important note is that face and eyewear frame types do not always fall completely into one category, rather they can be a blend between two as shown in FIG. 20 with first and second images 2010 and 2020 respectively for facial and eyewear frame blending respectively. Accordingly, in these instances we can consider the closest two types and compute a blending score by simply dividing by their sum. For the CBR with the eyewear frame an initial set of 50 photographs were employed for training and ˜250 for testing. If the scores are within, typically, the 60%-40% range then the inventors established the process as labelling this particular face and/or eyewear frame as a blend and during the recommendation processing allow recommendation from both face and/or eyewear frame classes.

B.3 The Survey

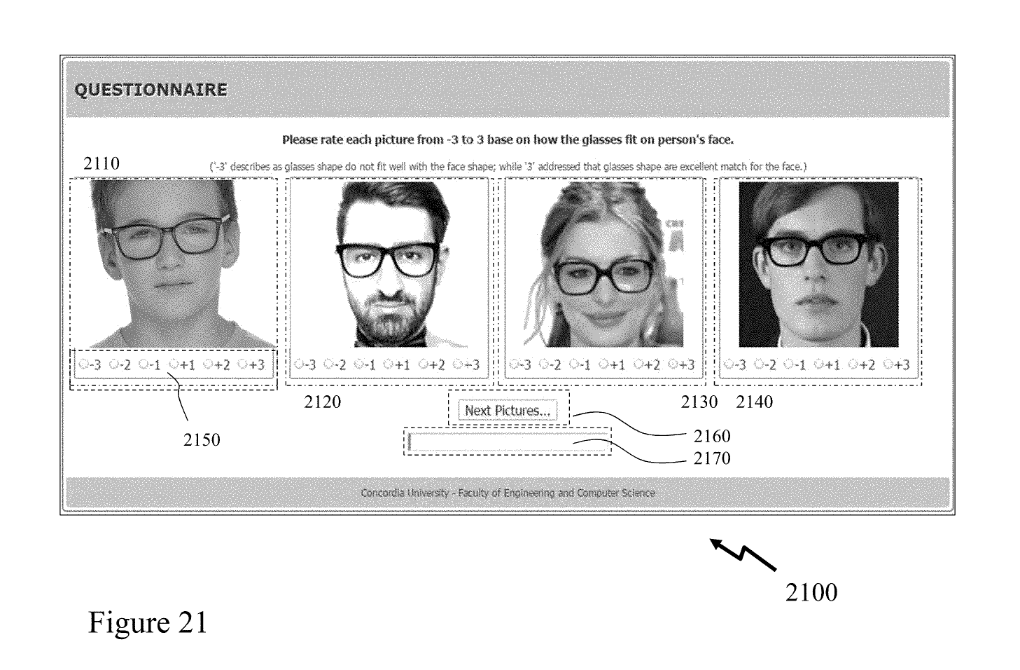

Within the preceding sections the inventors have presented algorithms and process methodologies relating to the automated classification of facial shape and eyewear frames from images provided to the software application embodying the embodiment of the invention. Within the CBR framework then the next step, a learning method is required to gather information from the users. In other words, to complete the CBR process preferred images should be chosen based on the user's preferences. For this stage the inventors exploited the server-side scripting language Php in conjunction with MySQL to develop a survey mechanism to input the user's idea based on images (which their face and eyewear frame classified, previously) and output the results. Referring to FIG. 21 there is depicted a view of the resultant website (http://users.encs.concordia.ca/am zafa/survey/) employed.

For each image, e.g. first to fourth images 2110 to 2140, the user can select a rating from −3 to +3, omitting 0, to indicate how much they like the visual appeal or fitness of the glasses upon a person's face. In order to target more reliable results, the pictures are repeated with a constant rate. Within the frame recommendation study performed by the inventors to demonstrate the full sequence a database of 240 pictures collected from the Internet were employed and the survey created asked the subjects to rate the compatibility between the face shape and the frame shape in each photograph on a scale from −3 to 3. Elimination of the “0” response negated the users providing too many neutral responses. Each subject of the survey voted on about 200 pictures picked at random and with over 100 participants the inventors obtained overall more than 25,000 records.

C: Results

Based upon the embodiments of the invention described supra and executed upon images the inventors discuss the results in this section.

C.1 Face Shape Recognition

Due to the “fuzzy” nature of the problem, the degree of membership for a new pattern is calculated based upon previous cases of CBR. The experiments performed by the inventors demonstrate that the system reuses the previously classified face patterns to predict the correct face shape type for any new face. Where faces are a blend then we consider the closest two types and a blending score is computed by simply dividing by their sum. If the scores are within 60%-40% range, we label the face type as a blend and during the recommendation type we allow recommendation from both face types.

TABLE 7
Confusion Matrix for FSRS System (Mean = 80.33%)

| | Oval | Diamond | Square | Heart | Oblong | Round |
|---|---|---|---|---|---|---|
| Oval | 79 | 2 | 3 | 2 | 4 | 5 |
| Diamond | 3 | 82 | 2 | 13 | 3 | 2 |
| Square | 2 | 1 | 85 | 1 | 10 | 5 |
| Heart | 3 | 11 | 3 | 75 | 5 | 3 |
| Oblong | 8 | 3 | 1 | 2 | 77 | 1 |
| Round | 5 | 1 | 6 | 7 | 1 | 84 |

Referring to Table 7 there is depicted the confusion matrix calculated after the testing phase, where the accuracy reached 80.33%. As evident the lowest accuracy was for oblong class where the highest error is for misclassification of square samples. The main cause would be the distance to ellipse miscalculation because of face boundary detection error of the system. The highest mistakes rate is for misclassification of Heart and Diamond classes (13 and 11, respectively) arose because of the fact that they are exceedingly similar classes. The main discrepancy would be the relative eye line of the face. Note that the confusion matrix summation on only vertical lines is equal to zero (not horizontally), by the reason of 60%-40% rule that applied to the system which previously described. Increased accuracy clearly depicts that the system trained itself after the first phase. This is because of the Case Based Reasoning, which allows system to recognize the face shape better after every iteration of testing with new samples.

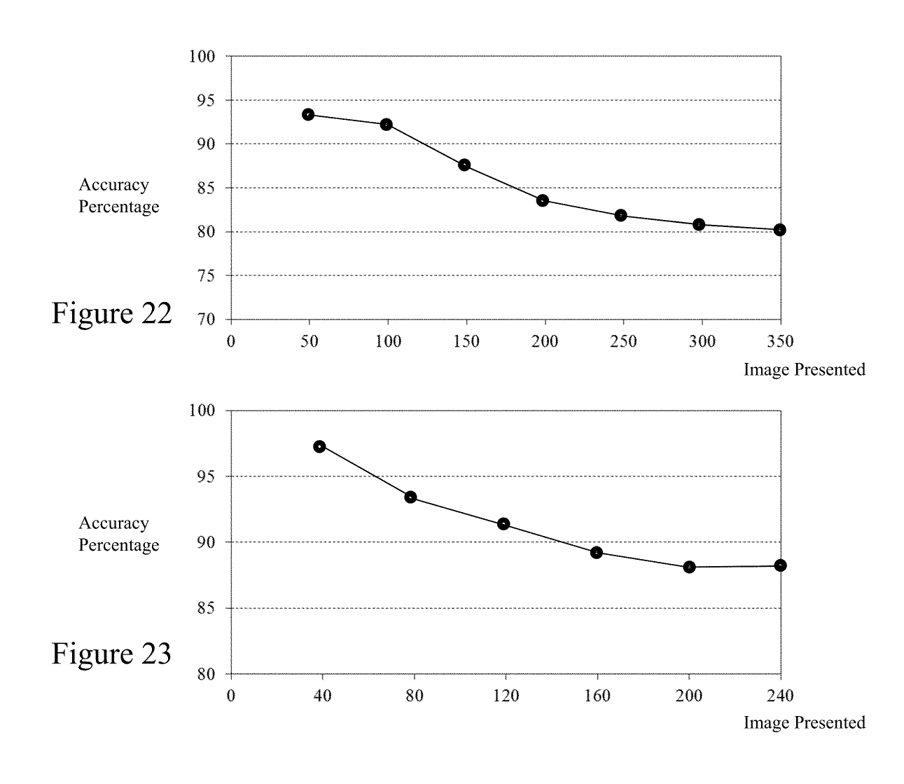

The inventors had over 100 different facial shapes assessed and recognized by domain experts such as fashion designers, hair stylists, etc. Subsequently, 300 new face shapes and 50 randomly selected from training data in 4 cycles were employed in cross-validation. These 4 cycles included rotation of training, testing and cross validation. The mean recognition accuracy was calculated based on 4-fold sequence as approximately 80%. The accuracy percentage of face classification during the training procedure is depicted in FIG. 22. It is evident that during testing, the accuracy decreased to reach a steady state about 80%. Out of the 20% misclassified faces it was estimated that half were misclassified due to partial failure of the face tracker step of process. The classification on a dataset that has correct face extraction is about 90%.

C.2 Frame Shape Recognition

As mentioned supra in classification sections, the face and eyewear frame parts bear resemblance in using CBR as the classification method. Since the frame extraction mechanism has a significant low error then the error in eyewear frame classification is relatively small. Referring to Table 8 the confusion matrix for the eyewear frame recognition system is presented where the mean value is approximately 88%, with the highest accuracy for the rectangular class. In other words, system is able to classify the rectangular frame class with the highest precision, owing to the high accuracy of the frame extraction precision which is the input of the frame classification.

TABLE 8
Confusion Matrix for Eyewear Frame Recognition System (Mean = 88%)

| | Oval | Wayfarer | Square | Aviator | Rectangular | Round |
|---|---|---|---|---|---|---|
| Oval | 87 | 0 | 1 | 0 | 4 | 1 |
| Wayfarer | 0 | 90 | 11 | 9 | 0 | 3 |
| Square | 2 | 5 | 83 | 4 | 1 | 0 |
| Aviator | 0 | 4 | 3 | 84 | 1 | 5 |
| Rec- | 6 | 0 | 2 | 1 | 93 | 0 |
| tangular | | | | | | |
| Round | 5 | 1 | 0 | 2 | 1 | 91 |

The highest error is caused by misclassification of square frames (83%) in wayfarer frame class (11%). This occurred since the interior polygon of these two frame classes are almost identical. The only significant differences are the distance to the fitted ellipse and the symmetry of the polygon. The inventors employed 60 photographs, 10 for each frame class, for training and 240 for testing. The frame shape extractor reconstructs a correct polygon nearly 97% of the time and the shape classifier achieves an accuracy of 88%. FIG. 23 depicts the accuracy diagram during the testing phase of the FSRS.

As indicated in overview of the system after defining a group of pictures of people with glasses to the system as input, the face and frame recognition procedures would be executed. The results show that the classifications are performed with over 80% accuracy and ready for the survey to be filled by users.

C.3 Eyewear Recommendation System and Validation

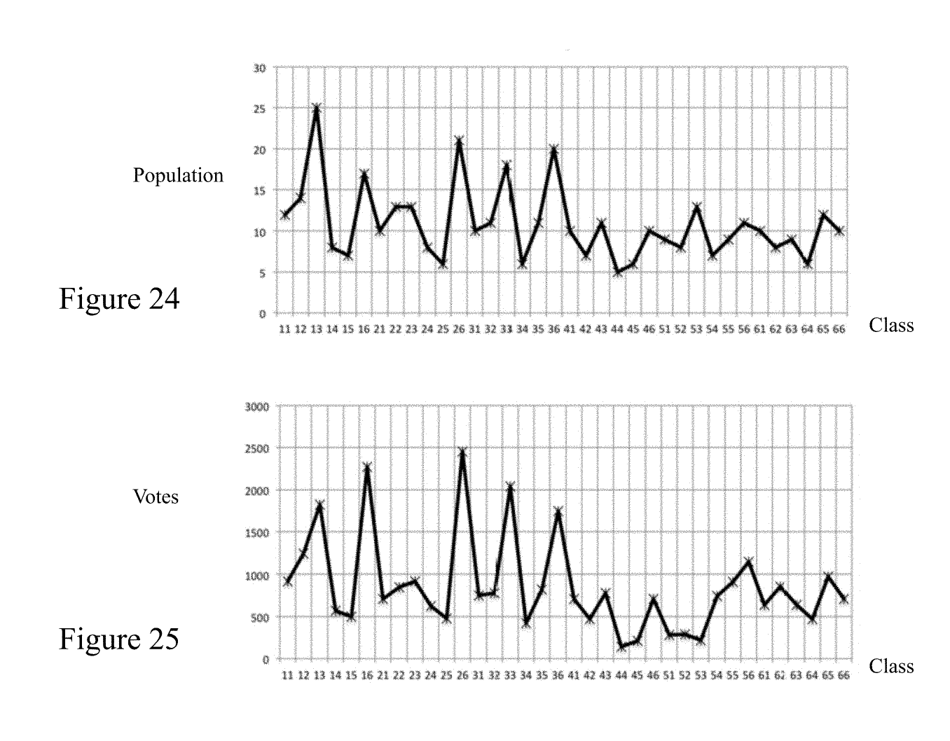

For each of the 6 face classes, there are 6 frame classes available, and the survey part of the FSRS system is responsible for weighting these 36 different classes based on users' point of view. Within this 250 images of people with glasses were collected from the Internet and the resulting population of each face/frame class is depicted in FIG. 24A. Within FIG. 24A the X-axis is face/frame number wherein the first number is face type (Oval, Square, Oblong, Round, Diamond, Heart) and second number is eyewear frame type (Oval, Round, Rectangular, Square, Aviator, Wayfarer). The vertical axis represents the number of pictures which related to this type of face/frame. As displayed the range of the image populations in each category range from 5 to 25. Further consideration of the survey results shows that the higher occurrence classes are from low face/high frame combinations. Now referring to FIG. 24B there are depicted the number of votes for each image in each class from the user. In the survey, each of 250 images was repeated with a probability to make the results more reliable. Overall, FIG. 25 shows that the number of votes after the polling process with about 100 participants range from 110 to 2470 for each single class. The classes with higher population received statistically higher numbers of votes.

FIG. 25 depicts the statistic results of the survey based on 100 participants' ideas. In this table, Mean, Median, Mode and Standard Deviation for each class is calculated for different types of frames/faces. Therefore, each of the 36 possible combinations of face shape and frame type received between 500 and 2,500 records. The discrepancy between the numbers comes from the fact that certain combination of face and eyeglass shapes are, unsurprisingly, more popular than others. Our recommendation system suggests the best two frame shapes for each input face shape based upon current fashions and polled user tastes. It would be evident that periodically performing the survey and/or incorporating purchasing data would allow capture of these potentially dynamic preferences. The results are summarised in Table 9.

TABLE 9
Recommendation Summary Based Upon Collected Data

| Face | 1^{st} Choice | 2^{nd} Choice |
|---|---|---|
| Oval | Rectangular | Square |
| Diamond | Aviator | Rectangular |
| Square | Square | Rectangular |
| Heart | Rectangular | Square |
| Oblong | Rectangular | Wayfarer |
| Round | Aviator | Square |

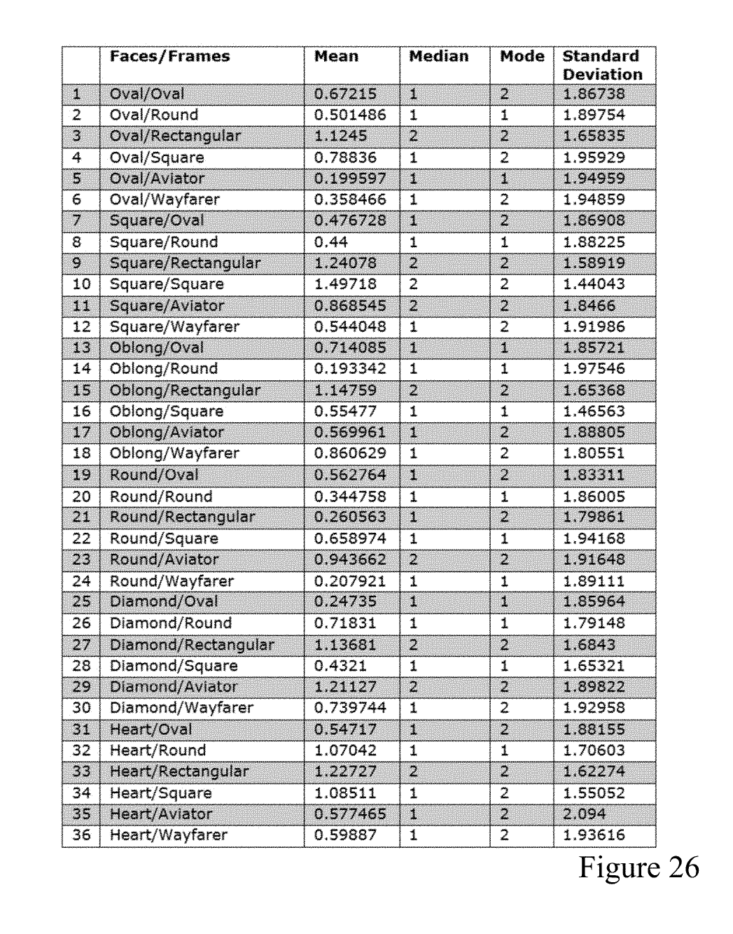

To validate our recommendation system, the inventors performed a follow up study. A set of pictures of individuals without glasses and using one of the virtual try-on online systems was collected. For each face type, four different types of frames were selected, two being ones that the recommendation system selected and 2 selected randomly. FIG. 26 depicts an example of one such record. The 42 participants were asked to select their favourite frame. 82% of the times the selection made coincided with one of the recommendations made by the software system according to the embodiment of the invention. Table 10 depicts the results of validation based on survey selected cases for each face shape.

TABLE 10
Validation Results

| Face | 1^{st} Choice | 2^{nd} Choice |
|---|---|---|
| Oval | Rectangular (64%) | Square (9%) |
| Diamond | Aviator (57%) | Rectangular (30%) |
| Square | Square (54%) | Rectangular (33%) |
| Heart | Rectangular (68%) | Square (20%) |
| Oblong | Rectangular (58%) | Wayfarer (23%) |
| Round | Aviator (35%) | Square (46%) |

Accordingly, it is evident that embodiments of the invention provide an automated software system for eyewear frame shape and classification methods for both face and eyewear frame shapes. The frame extraction and facial shape determination methods according to embodiments of the invention are more efficient, accurate and robust than previous methods.

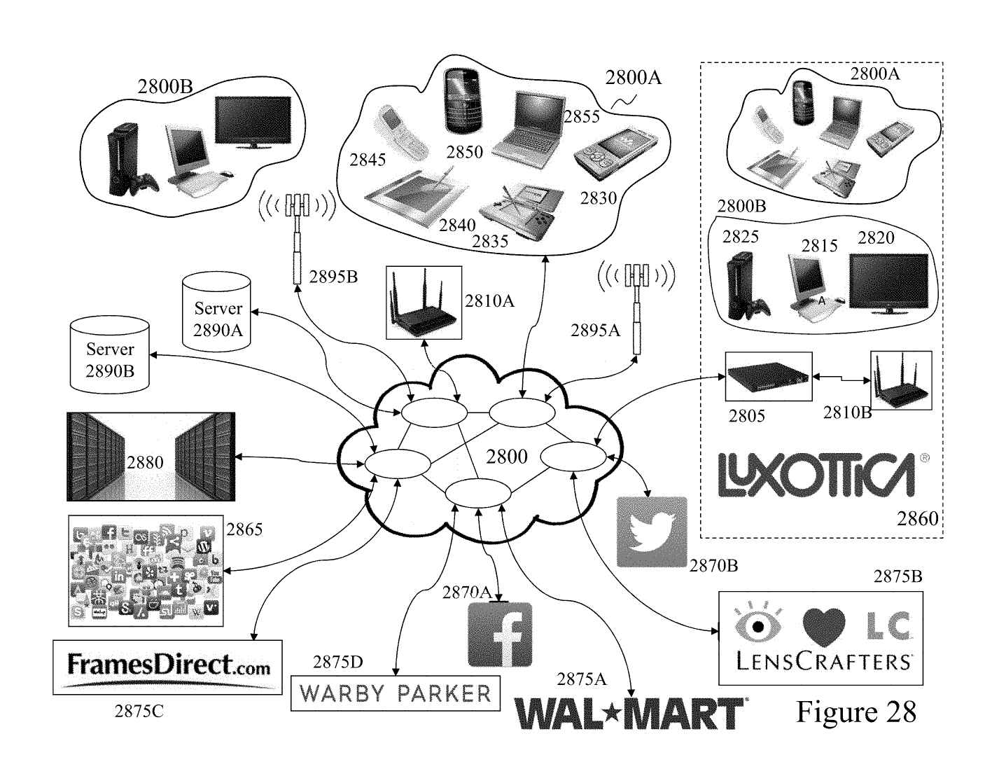

Referring to FIG. 28 there is depicted a network environment 2800 within which embodiments of the invention may be employed supporting publishing systems and publishing applications/platforms (PSPAPs) according to embodiments of the invention. Such PSPAPs, for example supporting multiple channels and dynamic content. As shown first and second user groups 2800A and 2800B respectively interface to a telecommunications network 2800. Within the representative telecommunication architecture, a remote central exchange 2880 communicates with the remainder of a telecommunication service providers network via the network 2800 which may include for example long-haul OC-48/OC-192 backbone elements, an OC-48 wide area network (WAN), a Passive Optical Network, and a Wireless Link. The central exchange 2880 is connected via the network 2800 to local, regional, and international exchanges (not shown for clarity) and therein through network 2800 to first and second cellular APs 2895A and 2895B respectively which provide Wi-Fi cells for first and second user groups 2800A and 2800B respectively. Also connected to the network 2800 are first and second Wi-Fi nodes 2810A and 2810B, the latter of which being coupled to network 2800 via router 2805. Second Wi-Fi node 2810B is associated with Enterprise 2860, e.g. Luxotica™, within which are other first and second user groups 2800A and 2800B. Second user group 2800B may also be connected to the network 2800 via wired interfaces including, but not limited to, DSL, Dial-Up, DOCSIS, Ethernet, G.hn, ISDN, MoCA, PON, and Power line communication (PLC) which may or may not be routed through a router such as router 2805.

Within the cell associated with first AP 2810A the first group of users 2800A may employ a variety of PEDs including for example, laptop computer 2855, portable gaming console 2835, tablet computer 2840, smartphone 2850, cellular telephone 2845 as well as portable multimedia player 2830. Within the cell associated with second AP 2810B are the second group of users 2800B which may employ a variety of FEDs including for example gaming console 2825, personal computer 2815 and wireless/Internet enabled television 2820 as well as cable modem 2805. First and second cellular APs 2895A and 2895B respectively provide, for example, cellular GSM (Global System for Mobile Communications) telephony services as well as 3G and 4G evolved services with enhanced data transport support. Second cellular AP 2895B provides coverage in the exemplary embodiment to first and second user groups 2800A and 2800B. Alternatively the first and second user groups 2800A and 2800B may be geographically disparate and access the network 2800 through multiple APs, not shown for clarity, distributed geographically by the network operator or operators. First cellular AP 2895A as show provides coverage to first user group 2800A and environment 2870, which comprises second user group 2800B as well as first user group 2800A. Accordingly, the first and second user groups 2800A and 2800B may according to their particular communications interfaces communicate to the network 2800 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 2800A may form associations either through standards such as IEEE 802.15 and Bluetooth as well in an ad-hoc manner.

Also connected to the network 2800 are Social Networks (SOCNETS) 2865, first and second online communities 2870A and 2870B respectively, e.g. Facebook™ and LinkedIn™ first to second retailers 2875A and 2875B respectively, e.g. WalMart™ and LensCrafters™, first and second online retailers 2875C and 2875D respectively, e.g. FramesDirect.com and Warby Parker, as well as first and second servers 2890A and 2890B which together with others, not shown for clarity. First and second servers 2890A and 2890B may host according to embodiments of the inventions multiple services associated with a provider of publishing systems and publishing applications/platforms (PSPAPs); a provider of a SOCNET or Social Media (SOME) exploiting PSPAP features; a provider of a SOCNET and/or SOME not exploiting PSPAP features; a provider of services to PEDS and/or FEDS; a provider of one or more aspects of wired and/or wireless communications; an Enterprise 2860 exploiting PSPAP features; license databases; content databases; image databases; content libraries; customer databases; websites; and software applications for download to or access by FEDs and/or PEDs exploiting and/or hosting PSPAP features. First and second primary content servers 2890A and 2890B may also host for example other Internet services such as a search engine, financial services, third party applications and other Internet based services.

Accordingly, a consumer and/or customer (CONCUS) may exploit a PED and/or FED within an Enterprise 2860, for example, and access one of the first or second primary content servers 2890A and 2890B respectively to perform an operation such as accessing/downloading an application which provides PSPAP features according to embodiments of the invention; execute an application already installed providing PSPAP features; execute a web based application providing PSPAP features; or access content. Similarly, a CONCUS may undertake such actions or others exploiting embodiments of the invention exploiting a PED or FED within first and second user groups 2800A and 2800B respectively via one of first and second cellular APs 2895A and 2895B respectively and first Wi-Fi nodes 2810A.

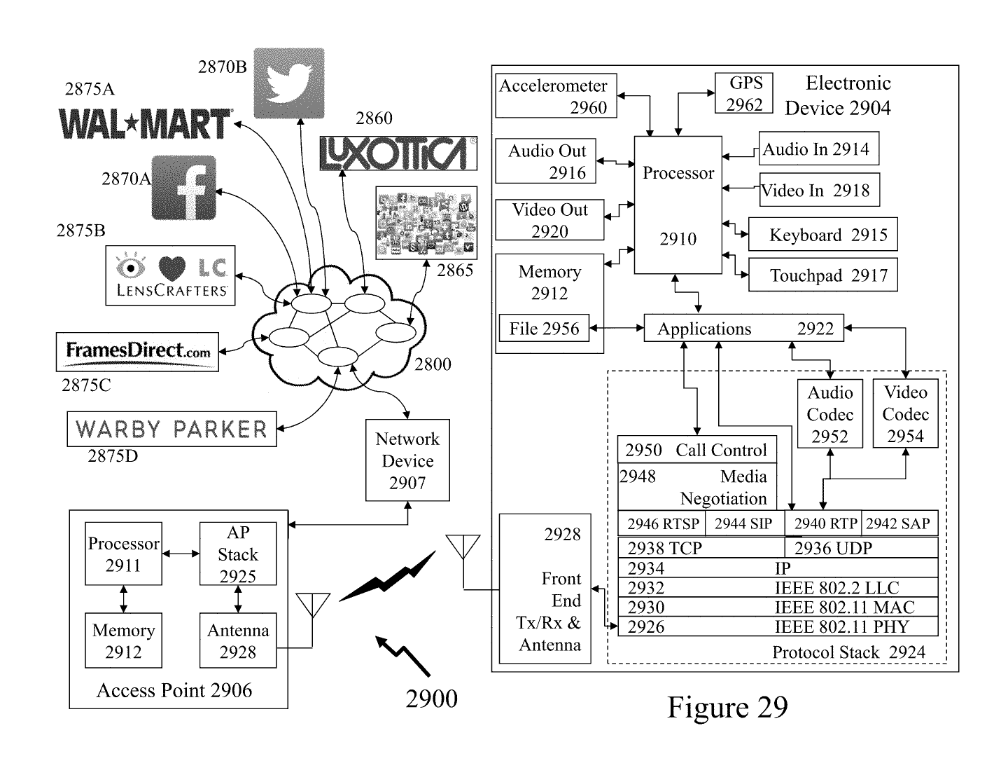

Now referring to FIG. 29 there is depicted an electronic device 2904 and network access point 2907 supporting PSPAP features according to embodiments of the invention. Electronic device 2904 may, for example, be a PED and/or FED and may include additional elements above and beyond those described and depicted. Also depicted within the electronic device 2904 is the protocol architecture as part of a simplified functional diagram of a system 2900 that includes an electronic device 2904, such as a smartphone 29855, an access point (AP) 2906, such as first AP 2810, and one or more network devices 2907, such as communication servers, streaming media servers, and routers for example such as first and second servers 2890A and 2890B respectively. Network devices 2907 may be coupled to AP 2906 via any combination of networks, wired, wireless and/or optical communication links such as discussed above in respect of FIG. 28 as well as directly as indicated. Network devices 2907 are coupled to network 2800 and therein Social Networks (SOCNETS) 2865, first and second online communities 2870A and 2870B respectively, e.g. Facebook™ and LinkedIn™, first to second retailers 2875A and 2875B respectively, e.g. WalMart™ and LensCrafters™, first and second online retailers 2875C and 2875D respectively, e.g. FramesDirect.com and Warby Parker.

The electronic device 2904 includes one or more processors 2910 and a memory 2912 coupled to processor(s) 2910. AP 2906 also includes one or more processors 2911 and a memory 2913 coupled to processor(s) 2910. A non-exhaustive list of examples for any of processors 2910 and 2911 includes a central processing unit (CPU), a digital signal processor (DSP), a reduced instruction set computer (RISC), a complex instruction set computer (CISC) and the like. Furthermore, any of processors 2910 and 2911 may be part of application specific integrated circuits (ASICs) or may be a part of application specific standard products (ASSPs). A non-exhaustive list of examples for memories 2912 and 2913 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 2904 may include an audio input element 2914, for example a microphone, and an audio output element 2916, for example, a speaker, coupled to any of processors 2910. Electronic device 2904 may include a video input element 2918, for example, a video camera or camera, and a video output element 2920, for example an LCD display, coupled to any of processors 2910. Electronic device 2904 also includes a keyboard 2915 and touchpad 2917 which may for example be a physical keyboard and touchpad allowing the user to enter content or select functions within one of more applications 2922. Alternatively, the keyboard 2915 and touchpad 2917 may be predetermined regions of a touch sensitive element forming part of the display within the electronic device 2904. The one or more applications 2922 that are typically stored in memory 2912 and are executable by any combination of processors 2910. Electronic device 2904 also includes accelerometer 2960 providing three-dimensional motion input to the process 2910 and GPS 2962 which provides geographical location information to processor 2910.

Electronic device 2904 includes a protocol stack 2924 and AP 2906 includes a communication stack 2925. Within system 2900 protocol stack 2924 is shown as IEEE 802.11 protocol stack but alternatively may exploit other protocol stacks such as an Internet Engineering Task Force (IETF) multimedia protocol stack for example. Likewise, AP stack 2925 exploits a protocol stack but is not expanded for clarity. Elements of protocol stack 2924 and AP stack 2925 may be implemented in any combination of software, firmware and/or hardware. Protocol stack 2924 includes an IEEE 802.11-compatible PHY module 2926 that is coupled to one or more Front-End Tx/Rx & Antenna 2928, an IEEE 802.11-compatible MAC module 2930 coupled to an IEEE 802.2-compatible LLC module 2932. Protocol stack 2924 includes a network layer IP module 2934, a transport layer User Datagram Protocol (UDP) module 2936 and a transport layer Transmission Control Protocol (TCP) module 2938.

Protocol stack 2924 also includes a session layer Real Time Transport Protocol (RTP) module 2940, a Session Announcement Protocol (SAP) module 2942, a Session Initiation Protocol (SIP) module 2944 and a Real Time Streaming Protocol (RTSP) module 2946. Protocol stack 2924 includes a presentation layer media negotiation module 2948, a call control module 2950, one or more audio codecs 2952 and one or more video codecs 2954. Applications 2922 may be able to create maintain and/or terminate communication sessions with any of devices 2907 by way of AP 2906. Typically, applications 2922 may activate any of the SAP, SIP, RTSP, media negotiation and call control modules for that purpose. Typically, information may propagate from the SAP, SIP, RTSP, media negotiation and call control modules to PHY module 2926 through TCP module 2938, IP module 2934, LLC module 2932 and MAC module 2930.

It would be apparent to one skilled in the art that elements of the electronic device 2904 may also be implemented within the AP 2906 including but not limited to one or more elements of the protocol stack 2924, including for example an IEEE 802.11-compatible PHY module, an IEEE 802.11-compatible MAC module, and an IEEE 802.2-compatible LLC module 2932. The AP 2906 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 2904 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

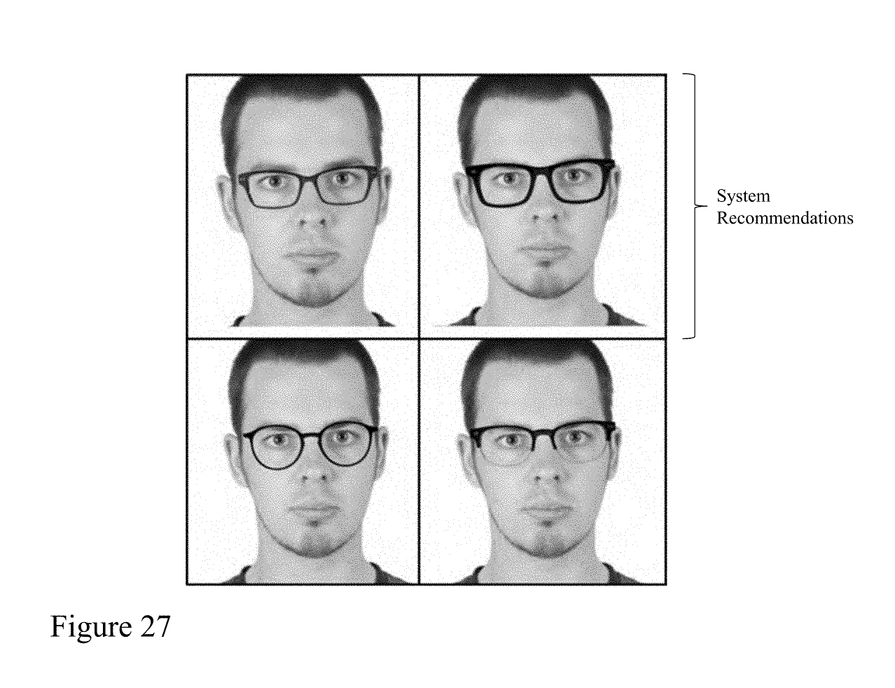

Within the embodiments of the invention described supra in respect of FIGS. 2 to 29 a user may classify their facial type and determine appropriate recommendations with respect to eyewear. However, it would be apparent that based upon the characterization, measurement, and assessment of the user's face that additional recommendation engines may exploit the core facial shape determination engine and leverage this to other aspects of the user's appearance and/or purchases. For example, recommendation engines fed from a facial shape determination engine may include those for hairstyles, hair accessories, wigs, sunglasses, hats, earrings, necklaces, beards, moustaches, tattoos, piercings, makeup, etc. Further, it would be evident that the facial shape determination, recommendation engine etc. may be provided to a user locally upon a PED, FED, terminal, etc. or that the user may exploit such engines remotely via a network or the Internet through remote server based provisioning of the required engines, classifications, etc.

Similarly, surveys as presented and discussed supra may be supported and enabled through networks such as the Internet either as managed and controlled by manufacturers, providers, third party providers, etc. or as driven through other network based activities such as crowd sourcing, social media, social networks, e-commerce etc. Such online surveys may rapidly establish results across geographical boundaries, across wide demographics, etc. whilst e-commerce based data such as purchaser face shape and purchased eyewear frame class, for example, may provide not only survey data but also indications of evolving preferences and/or tastes.

Within embodiments of the invention a user may submit an image, receive a recommendation, and post that to their social network. Their social network may provide feedback that is added to the survey results such that over time the survey results are augmented/expanded. As the embodiments of the invention provide for normalized dimensional analysis of the user's face then the recommendations/simulations of the user with an item of apparel/style etc., e.g. eyewear, may include the appropriately dimensioned augmentation of their uploaded/captured image rather than the crude inaccurate overlays within the prior art.

Within embodiments of the invention the user may, for example, acquire an image upon their PED, transfer this to a remote server via a network for processing and receive back a recommendation. In this manner the classification engine etc. may be remotely hosted reducing the processing requirements upon the user's PED. In embodiments of the invention the overall system may be contextually aware such that the user's location, for example, within an eyewear retailer leads to recommendations driven by the available eyewear frames, for example, available from that retailer. Optionally, the user may establish a profile with a provider of classification based recommendation services such that upon subsequent online visits the user does not need to provide an image for facial type analysis as the results of their previous visit(s) are stored against their unique account credentials.

Optionally, within embodiments of the invention the recommendation process may, in specific instances such as replacement or celebrity/trend following, establish a recommendation based upon additional and/or modified criteria. For example, if the user has a reference eyewear frame, e.g. one they have purchased previously or one that a celebrity uses, that the recommendation engine may employ data relating to the identified eyewear frame and provide recommendations based upon this and the user's facial type.

Within the embodiments of the invention presented and discussed supra in respect of FIGS. 2 to 29 the recommendations, of eyewear frames for example, are essentially broad classes, e.g. oblong versus round. However, it would be evident to one skilled in the art that the methodologies and embodiments of the invention may be applied at finer granularity with respect to different items, for example eyewear frames, such that, for example, different oblong eyeframes are ranked/rated against a particular facial type. Accordingly, a granular hierarchy of recommendations may be presented to the user such that upon picking, for example, oblong eyeframes they are then presented with recommendations with respect to other aspects of the eyewear frame such as visible frame, invisible frame, colour, arms attaching middle of frame or high on frame, etc. It would be evident that some finer granularity recommendations may require additional characterization of the user's facial profile, e.g. large nose, low nose, wide bridge, high ears, low ears, etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method comprising:
automatically establishing with a microprocessor based system a facial shape for a user based upon an image of the user provided to the microprocessor based system comprising a classification engine, wherein
the classification engine automatically processes the image of the user with a predetermined classifier exploiting a training set.

2. The method according to claim 1, wherein
the predetermined classifier exploited is at least one of based upon a case based reasoning methodology and can correctly classify the facial shape even when it falls between two classes.

3. The method according to claim 1, wherein
the training set classifications are provided by at least one of experts, non-experts, social media based recommendations, purchasing histories, and user browsing history.

4. The method according to claim 1, wherein
the microprocessor based system comprises a plurality of modules; wherein
a first module of the plurality of modules provides for facial boundary detection based upon a provided image, the facial boundary detection establishing a predetermined number of boundary points;
a second module of the plurality of modules provides for feature extraction based upon the boundary points established by the first module, the feature extraction comprising the generation of predetermined geometric shapes based upon first subsets of the boundary points and dimensions established upon second subsets of the boundary points;
the classification module is a further module of the plurality of modules determining the facial shape in dependence upon the features extracted by the second module and a plurality of datasets, each of the datasets established from feature extraction performed upon a training set of images relating to a defined facial shape of a plurality of defined facial types.

5. The method according to claim 1, further comprising:
automatically establishing an eyewear frame class of a plurality of eyewear frame classes for the user with a microprocessor based system, wherein
the classification engine automatically processes the image based upon a first case based reasoning methodology exploiting a first training set to define a facial shape of the user and associates the defined facial shape with an eyewear frame class of a plurality of eyewear frame classes; and
the associations between facial shapes and eyewear frame classes were previously established by the classification engine based upon a second case based reasoning methodology exploiting a second training set of images comprising images of other users wearing eyewear frames.

6. The method according to claim 5, wherein
the first case based reasoning methodology can correctly classify the user's facial shape even when it falls between two classes.

7. The method according to claim 5, wherein
second case based reasoning methodology exploits training set classifications provided by at least one of experts, non-experts, social media based recommendations, purchasing histories, and user browsing history.

8. The method according to claim 1, wherein
the image of the user comprises the user wearing a current eyewear frame; and
the microprocessor based system:
automatically establishes a digital fingerprint of the current eyewear frame worn by the user within the image of the user; and
automatically establishes a frame class for the eyewear frame.

9. The method according to claim 8, wherein
the digital fingerprint of the eyewear frame is established by a process comprising:
preprocessing the image to reduce noise within the image;
extracting a plurality of edge polygons from the pre-processed image;
determining a line of symmetry within the image;
selecting symmetric contours within the plurality of edge polygons based upon the line of symmetry;
calculating convex hulls of the identified pairs of symmetric contours;
determining intersections of the symmetric contours and fitting a continuous mathematically defined polygon;
calculating areas of the calculated convex hulls and the continuous mathematically defined polygon;
ranking the convex hulls based upon the continuous mathematically defined polygon area, the number of intersections, and convex hull area;
determining whether the highest rank convex hull satisfies a predetermined threshold, wherein satisfaction of the predetermined threshold defines the digital fingerprint of the eyewear frame as the highest ranked convex hull.

10. A method of providing a recommendation to a user with respect to an item comprising:
automatically establishing with a microprocessor based system a facial shape for a user based upon an image of the user provided to the microprocessor based system comprising a classification engine which automatically processes the image of the user with a predetermined classifier exploiting a training set; and
automatically establishing a class of the item in dependence upon the facial shape of the user and the results of a survey executed in respect of a plurality of classes of the item and a plurality of facial types; and
automatically generating a recommendation in dependence upon the established class of the item.

11. The method according to claim 10, wherein
the predetermined classifier exploited is at least one of based upon a case based reasoning methodology and can correctly classify the facial shape even when it falls between two classes.

12. The method according to claim 10, wherein
the survey was conducted with at least one of experts, non-experts, social media users, and purchasing histories of users for the item involving at least one of image acquisition of the user with the item and user input.

13. The method according to claim 10, wherein
the survey results are filtered in dependence upon at least one of a geographical location of the user, a gender of the user, an age of the user, a brand, a retailer, a manufacturer, geographical locations of the surveyed individuals, the gender of the surveyed individuals, an age range of the surveyed individuals.

14. The method according to claim 10, wherein
the survey executed in respect of a plurality of classes of the item and a plurality of facial types comprises:
providing to each surveyed user of a plurality of surveyed users a plurality of images, each image within the plurality of images comprising an image of an individual of a plurality of individuals within a user class of a plurality of user classes and an item within an item class of a plurality of item classes;
receiving the responses from the plurality of surveyed users with respect to the plurality of images; and
ranking the item classes for each of the plurality of user classes in dependence upon the received responses.

15. The method according to claim 10, wherein
the survey executed in respect of a plurality of classes of the item and a plurality of facial types comprises:
acquiring a plurality of purchased item data records each comprising an identity of an individual and an identity of an item;
classifying each individual to a user class of a plurality of user classes;
classifying each item to an item class of a plurality of item classes; and
establishing a ranking for each user class of the plurality of user classes for the plurality of item classes.

16-22. (canceled)

23. The method according to claim 15, wherein
automatically establishing a class of the item in dependence upon the facial shape of the user and the results of a survey comprises:
receiving data relating to the user;
automatically classifying the user to a user class of the plurality of user classes; and
providing the highest ranked item class of the plurality of item classes for the classified user class of the plurality of user classes of the user.
